(19) United States
(12) Patent Application Publication
(10) Pub. No.: US 2011/0032731 A1
(43) Pub. Date: Feb. 10, 2011

(54) MULTIPLE INDEPENDENTLY REGULATED PARAMETERS USING A SINGLE MAGNETIC CIRCUIT ELEMENT

(75) Inventors: Charles Coleman, Fort Collins, CO (US); George Rasko, San Jose, CA (US); Sam Seiichiro Ochi, Saratoga, CA (US); Ernest H. Wittenbreder, JR., Flagstaff, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ASIC Advantage Inc., Sunnyvale, CA (US)

(21) Appl. No.: 12/850,120

(22) Filed: Aug. 4, 2010

Related U.S. Application Data
(60) Provisional application No. 61/231,116, filed on Aug. 4, 2009.

(51) Int. Cl. H02M 3/335

(52) U.S. Cl. 363/21.12

(57) ABSTRACT

Methods, systems, and devices are described for using isolated and non-isolated circuit structures and control methods for achieving multiple independently regulated input and output parameters using a single, simple, primary magnetic circuit element. For example, structures and methods are revealed for achieving single-stage power factor correction with high power factor and multiple independently regulated outputs using a single, simple, primary magnetic circuit element. Other structures and methods are revealed for achieving multiple independently regulated outputs without power factor correction using a single primary magnetic circuit element for both isolated and non-isolated power conversion applications.

### CROSS-REFERENCES

This applications claims priority from co-pending U.S. Provisional Patent Application No. 61/231,116, filed Aug. 4, 2009, entitled “MULTIPLE INDEPENDENTLY REGULATED PARAMETERS USING A SINGLE MAGNETIC CIRCUIT ELEMENT”, which is hereby incorporated by reference, as if set forth in full in this document, for all purposes.

### BACKGROUND

Embodiments described herein generally pertain to electronic power conversion circuits, and, more specifically, to single-stage power conversion architectures configured concurrently to regulate multiple parameters.

Some electronics applications desire to control multiple parameters of a circuit concurrently. For example, it may be desirable to control both power factor and certain load output parameters (e.g., load current, load voltage, etc.). Many techniques control these parameters by applying multiple power converter circuits in stages to affect each parameter in turn. As such, controlling multiple parameters may typically involve using multiple magnetic elements.

For example, an embodiment of a prior art multi-stage converter circuit 100 for controlling multiple parameters is shown in FIG. 1. The converter circuit 100 includes a first stage 110 with a first converter, boost converter 130, and a second stage 140 with a second converter, isolated forward converter 150. A rectified AC input voltage 120 is received by the first stage 110 where a first parameter is controlled, communicated to the second stage 140 where a second parameter is controlled, and output across a load 160.

In the embodiment shown, the boost converter 130 in the first stage 110 is used to achieve precise line current regulation, while the isolated forward converter 150 in the second stage 140 is used to achieve precise load 160 voltage regulation. The output of boost converter 130 is a loosely regulated voltage applied to a bulk capacitor, typically in the form of a large electrolytic capacitor having a voltage that may vary by as much as ten percent or more at maximum load 160 over the course of a line frequency cycle. The second stage 140 post-regulator (isolated forward converter 150) may be selected to offer good performance and to be reasonably efficient in applications where the line voltage range is limited, as it is following the boost converter 130.

Notably, the boost converter 130 includes one magnetic element (e.g., an inductor) and the isolated forward converter 150 includes another magnetic element (e.g., a transformer). For electronics applications in which it is desired to minimize size and cost, this two-stage approach may be unattractive. While some single-stage techniques are available, they may be unable to precisely and independently regulate multiple parameters concurrently (e.g., performance of some or all of the parameter regulation is compromised to achieve the single-stage architecture).

### BRIEF SUMMARY

Among other things, novel isolated and non-isolated circuit structures and control methods are provided for achieving multiple independently regulated parameters using a single simple magnetic circuit element. Some embodiments include systems and methods for achieving single-stage power factor correction (PFC) with high power factor and multiple independently regulated outputs using a single simple magnetic circuit element. Other embodiments include systems and methods for achieving multiple independently regulated outputs without power factor correction using a single magnetic circuit element for both isolated and non-isolated power conversion applications.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

FIG. 1 shows an embodiment of a prior art multi-stage converter circuit for controlling multiple parameters.

FIG. 2A shows a simplified block diagram of an illustrative single-stage power converter circuit for concurrently controlling multiple parameters, according to various embodiments.

FIGS. 2B and 2C show additional embodiments of single-stage power converter circuits for concurrently controlling multiple parameters, like the one shown in FIG. 2A.

FIG. 3A illustrates a zero-voltage switching (ZVS) coupled inductor boost converter according to the subject invention.

FIG. 3B shows an embodiment similar to the one shown in FIG. 3A except that the relative positioning of the clamp diode in relation to the output capacitor and the load is reversed.

FIGS. 4A and 4B illustrate additional embodiments similar to the embodiments in FIG. 3A and FIG. 3B, respectively.

FIGS. 5A and 5B show embodiments that obviate a clamp diode by placing a bulk energy storage capacitor in a secondary circuit as a second unloaded higher voltage output.

FIG. 6 illustrates another embodiment similar to the embodiment in FIG. 5A.

FIG. 7 illustrates an embodiment similar to the FIG. 6 embodiment, but with the bulk capacitor connected in series with the line so that the primary winding voltage will have a minimum value during the first operating state over a line cycle and the duty cycle will have a maximum value over a line cycle.

FIG. 8 illustrates an embodiment similar to the embodiment of FIG. 7 except that the bulk energy storage capacitor is provided with its own winding tap separate from the winding tap provided for the output.

FIG. 9 illustrates another embodiment that is similar to the embodiment of FIG. 7, except that the FIG. 9 embodiment has two independently regulated outputs, and the relative positions of switches and capacitors are reversed relative to the positions illustrated in the FIG. 7 embodiment.

FIG. 10 illustrates an embodiment similar to the embodiment of FIG. 5A, but with a bulk capacitor connected in series with the rectified source.

FIG. 11 is another embodiment similar to the FIG. 10 embodiment except that a tertiary winding is added and connected to the primary circuit network.

FIGS. 12 and 13 illustrate flyback converters having three operating states.

FIG. 14 illustrates an embodiment similar to the FIG. 13 embodiment in which a tertiary winding is added to the coupled inductor for separately accommodating the booster capacitor and for providing a separate fully isolated load network connected to the secondary winding.

FIG. 15 illustrates another embodiment having a tertiary winding for the bulk energy storage capacitor but without a booster capacitor.

FIG. 16A illustrates a coupled inductor boost embodiment in which there are three operating states.

FIG. 16B illustrates an embodiment similar to the FIG. 16A embodiment in which the relative positions of capacitors and switches are reversed in the secondary network.

FIG. 16C illustrates an embodiment similar to the FIG. 16A embodiment in which the relative positions of the forward diode and the forward capacitor are reversed.

FIG. 17 illustrates an embodiment similar to the FIG. 16A embodiment in which the secondary winding of the coupled inductor is common with a section of the primary winding in a tapped inductor configuration.

FIG. 18 illustrates a coupled inductor boost converter similar to the FIG. 16A embodiment that uses a booster capacitor according to the subject invention.

FIG. 19 illustrates an embodiment that operates in a manner similar to the FIG. 18 embodiment, except that it uses a tapped inductor wherein the secondary winding is formed from a section of the primary winding.

FIG. 20 illustrates another embodiment similar to the FIG. 19 embodiment, but with the addition of a second output.

FIG. 21 illustrates another embodiment similar to the FIG. 18 embodiment but with an isolated output and a tertiary winding coupled to the coupled inductor for exchanging energy with the booster capacitor.

FIG. 22 illustrates an embodiment similar to the FIG. 21 embodiment but with two independently regulated outputs controlled in the manner described above for the FIG. 20 embodiment.

FIG. 23 illustrates another embodiment similar to the FIG. 18 embodiment wherein the output capacitor serves as a booster capacitor.

FIG. 24A shows an embodiment similar to the FIG. 23 embodiment except with an additional second output having a second output capacitor which serves as a booster capacitor.

FIG. 24B is similar to the FIG. 24A embodiment except that relative positions of switches and output capacitors are reversed.

FIG. 25 illustrates an embodiment using a flyback implementation similar to the FIG. 12 embodiment but with several changes.

FIG. 26 illustrates an embodiment that combines buck and buck boost embodiments.

FIG. 27 shows an illustrative method for implementing high power factor correction concurrently with independently regulated outputs using a single magnetic element, according to various embodiments.

FIG. 28 shows a simplified block diagram of an illustrative circuit for providing independent output regulation, according to various embodiments.

FIG. 29A illustrates an embodiment in which a flyback converter has two independently regulated outputs that share a common secondary winding.

FIG. 29B embodiment is similar to the FIG. 29A embodiment, except that the relative positions of switches and outputs are reversed in the secondary circuit networks of the two embodiments and the relative position of switch and winding is reversed in the primary circuit network.

FIGS. 30A-C illustrate a mode of operation in which a flyback transformer embodiment has a small inductance and operates in discontinuous conduction mode.

FIGS. 31A-C illustrate a zero voltage switching control mode of operation for flyback converter embodiments.

FIGS. 32A-H illustrate variations in primary circuit networks that can be made according to the embodiments of FIG. 29A and FIG. 29B that represent additional embodiments.

FIGS. 33A-H, J, K, M, and N illustrate variations in secondary circuit networks for coupled inductor boost converters according to various embodiments.

FIGS. 34A-D illustrate current waveforms for continuous conduction mode.

FIGS. 35A-D illustrate current waveforms for discontinuous conduction mode.

FIGS. 36A-D illustrate current waveforms for critical conduction mode.

FIGS. 37A-D illustrate current waveforms for zero-voltage switching (ZVS) boundary mode.

FIGS. 38A-D illustrate current waveforms for discontinuous conduction mode.

FIGS. 39A-D illustrate current waveforms for continuous conduction mode.

FIGS. 40A-D illustrate current waveforms for critical conduction mode.

FIGS. 41A-D illustrate current waveforms for ZVS boundary mode.

FIG. 42 illustrates a boost embodiment of the subject invention that will produce at least one output voltage that is higher than the input voltage.

FIGS. 43A and 43B illustrate boost embodiments similar to the FIG. 42 embodiment in which the switches are divided into two parts, one part of which comprises diode rectifiers, which prevent an output capacitor discharging current, and switches having the ability to block output capacitor charging current.

FIGS. 44A and 44B illustrate embodiments similar to those in FIGS. 43A and 43B, respectively, except using synchronous rectifiers instead of diode rectifiers.

FIG. 44C shows an embodiment similar to the FIG. 44B embodiment in which second output is unloaded and serves to reverse an inductor current so that magnetizing energy in an inductor will be available to drive a ZVS turn-on transition for a first switch when a second switch is turned OFF.

FIG. 45 is a buck converter embodiment.

FIGS. 46A-D show current waveforms for the embodiment of FIG. 45.

FIG. 47 shows an embodiment that combines buck and boost embodiments using a single common choke.

### DETAILED DESCRIPTION

Embodiments are described herein for providing novel power converters that use a single power converter stage (i.e., a single large, primary magnetic element) to achieve multiple independently regulated outputs or substantially simultaneous independent regulation of two different circuit parameters. In some embodiments, power factor control (PFC) and load voltage and/or current are independently and precisely controlled concurrently by a single power converter stage. Other embodiments include novel multi-output coupled inductor power converters having independently regulated outputs using a single magnetic circuit element.

In this description and throughout this application “connected” shall mean that there exists “a direct wire path for conduction of an electrical current between the two points of the circuit identified as being connected, without the existence of intervening circuit elements sufficiently large in impedance to alter the current or create a voltage difference between the two points that is not substantially zero.” A MOSFET having a source connected to a ground terminal through a current sense resistor may be considered to be connected, but two nodes having an element that can have a high impedance such as an inductor, capacitor, or a switch are not considered to be connected.

A “switch” shall mean “an electrical circuit element that can have two electrical states, one of which substantially blocks current flow through the element and the other of which allows current flow through the element substantially unimpeded.” Examples of switches shall include, at a minimum, rectifier diodes, transistors, relays, and thyristors. “Coupled” shall mean that two nodes have either a low impedance AC or DC path between them so that two nodes with only a capacitor or inductor between them may be considered to be coupled, but not connected. Any two circuit nodes that are connected are also coupled, but not vice versa. “Power factor” is a measure of the phase difference between a line voltage and a line current. Power factor is also a measure of the distortion of a line current waveform with respect to the corresponding line voltage waveform.

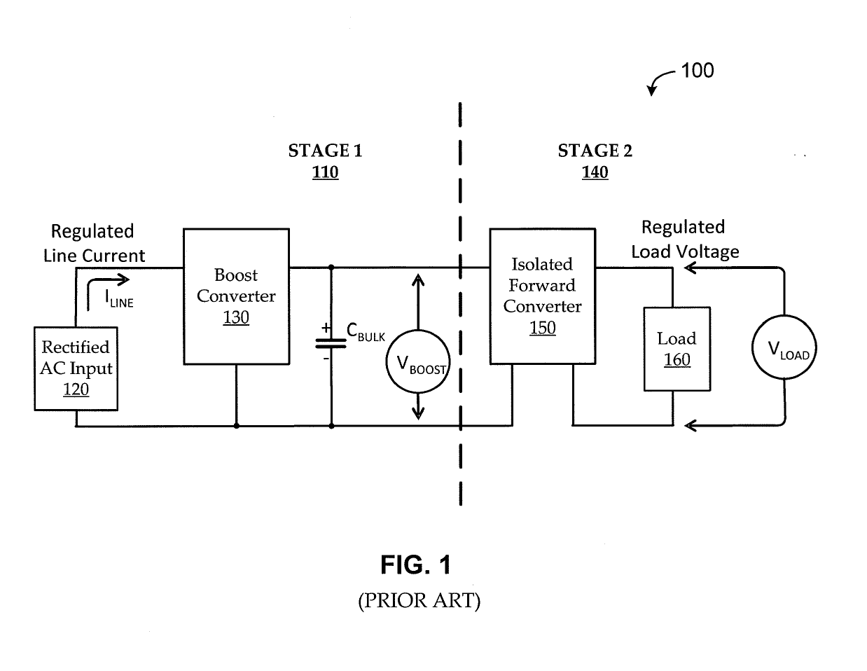

Further, embodiments are described herein as using a “single power converter,” a “single power converter stage,” a “single magnetic element,” and the like. It is acknowledged that these embodiments may be used in the context of additional magnetic elements (e.g., inductors, etc.) configured to provide other features to the circuit, and should not be construed to the contrary. However, this phraseology is intended to highlight the single-stage nature of these embodiments (i.e., to contrast these embodiments from multi-stage architectures, like the one discussed with reference to FIG. 1).

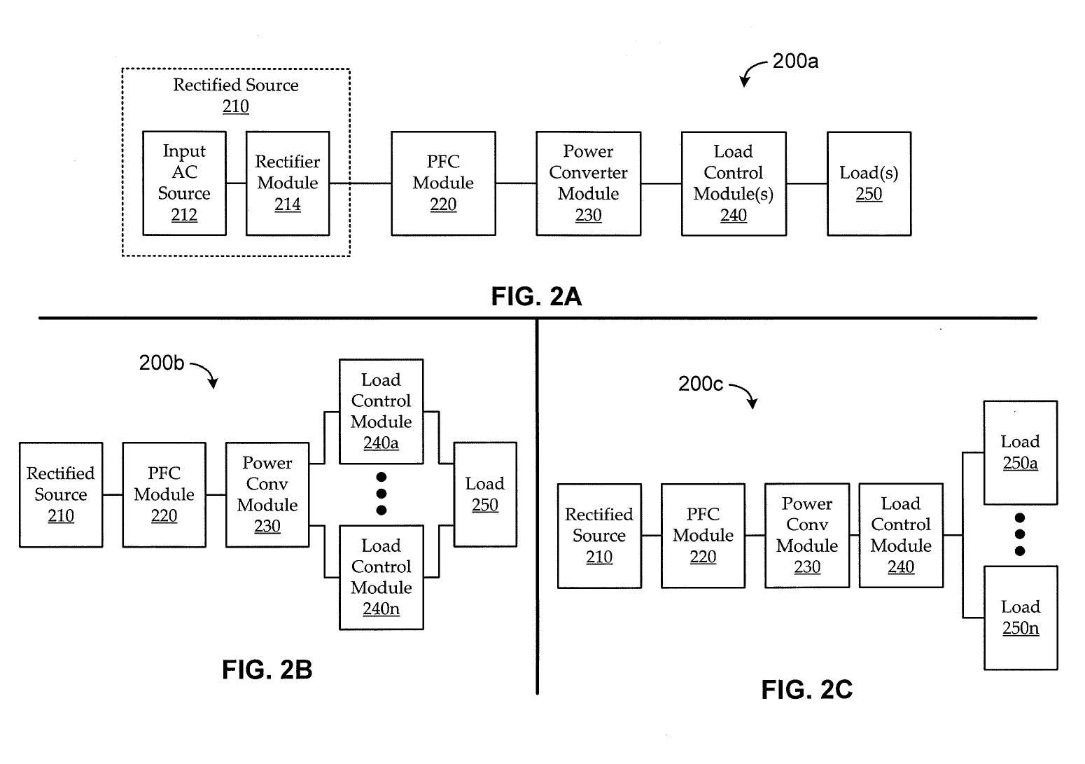

Turning first to FIG. 2A, a simplified block diagram is shown of an illustrative single-stage power converter circuit 200a for concurrently controlling multiple parameters, according to various embodiments. The circuit 200a includes a single power converter module 230 having a single magnetic element. Though in a single-stage topology, the power converter module 230 is configured to independently, precisely, and concurrently regulate multiple parameters. As illustrated, the power converter module 230 is coupled with a PFC module 220 and one or more load control modules 240.

In one embodiment, an input AC source 212 is received at an input side of the circuit 200a. The input AC source 212 is rectified by a rectifier module 214 into a rectified source 210. For example, an un-rectified line voltage may be rectified by a diode bridge or any other useful rectifier circuit known in the art.

The rectified source 210 is passed to the PFC module 220, which may apply power factor control to the input signal. For example, the PFC module 220 may phase-correct the current and voltage of the rectified source 210 signal. In some embodiments, the PFC module 220 functionality is implemented as switches and/or other elements integrated with certain operational features of the power converter module 230 to affect power factor.

The load control modules 240 may affect delivery of the signal to a load 250. For example, the power-factor-corrected signal may be independently regulated so that the load 250 experiences a substantially precise load current, load voltage, load power, etc. In some embodiments, one or more load control modules 240 are used to regulate load parameters for one or more loads. As with the PFC module 220, embodiments of the load control modules 240 are implemented as switches and/or other elements integrated with certain operational features of the power converter module 230 to affect load parameters.

FIGS. 2B and 2C show additional embodiments of single-stage power converter circuits 200 for concurrently controlling multiple parameters, like the one shown in FIG. 2A. FIG. 2B is similar to FIG. 2A, except that multiple load control modules 240 are used to independently and concurrently control multiple parameters of a single load 250 through interactions with the single power converter module 230. FIG. 2C is similar to FIG. 2A, except that a single load control module 240 is used to independently and concurrently control parameters of multiple loads 250 through interactions with the single power converter module 230. As described above, other embodiments may include multiple load control modules 240 independently and concurrently controlling multiple parameters of multiple loads 250 through interactions with the single power converter module 230.

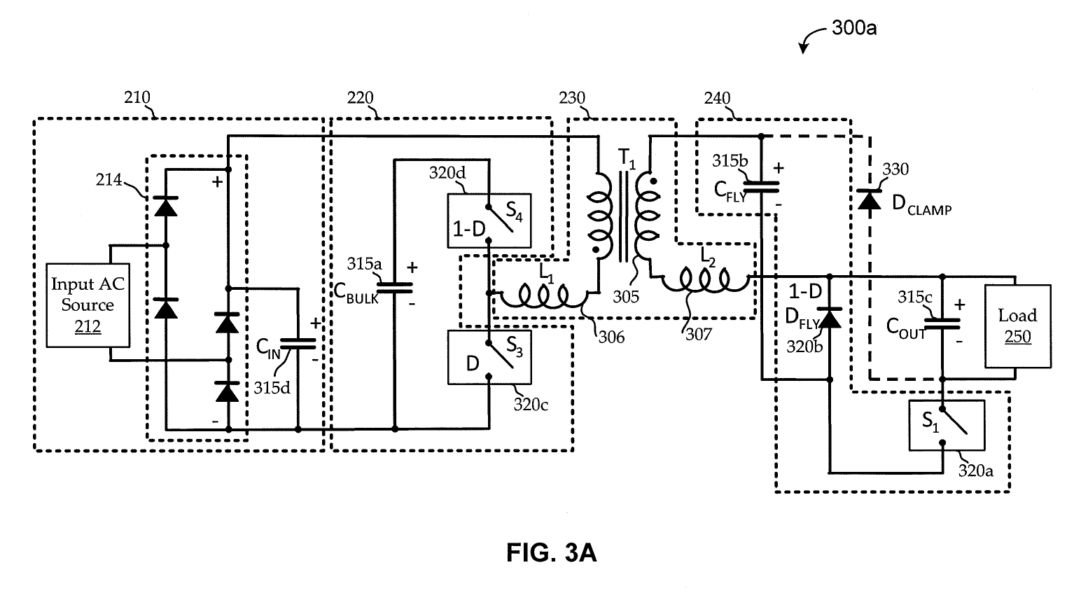

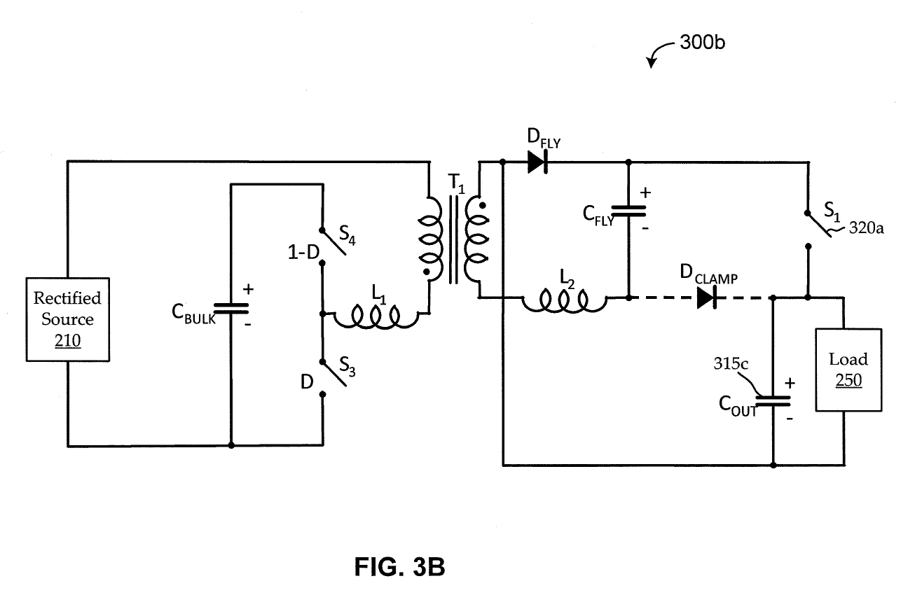

The following figures enable a number of illustrative embodiments of the circuits 200 shown in FIGS. 2A-2C. While the circuits have been provided in simplified form, enough detail has been provided so that operation of the circuits will be appreciated by those of skill in the art. For example, FIG. 3A illustrates a zero-voltage switching (ZVS) coupled inductor boost converter circuit 300a, according to various embodiments. For the sake of clarity, the converter circuit 300a is shown in context of various functional blocks of the circuit 200a of FIG. 2A. For example, the circuit 300a is illustrated as including a single power converter module 230 having a single magnetic element (coupled inductor 305). The power converter module 230 is coupled with a PFC module 220 and a load control module 240. An input side of the circuit 300a is coupled with an input AC source 212 connected to a full wave rectifier module 214 to produce a rectified source 210. The output of the load control module 240 is delivered to a load 250.

The positive terminal of the rectifier module 214 is connected to the positive terminal of input capacitor 315d and to the undotted terminal of a primary winding of a coupled inductor 305. Input capacitor 315d will be a relatively small value capacitor, which will enhance the electromagnetic compatibility at the input. Input capacitor 315d provides a low AC impedance that allows high frequency AC current to flow at the rectifier module 214 output without large voltage swings at the rectifier module 214 output. The input capacitor 315d voltage follows the input AC source 212 voltage at the input to the rectifier module 214, but its voltage is substantially invariant over a high frequency switching cycle of the boost converter 300a. In the context of this specification, substantially shall mean mostly or for the most part but may or may not include precisely. The coupled inductor 305 is a magnetic circuit element that provides magnetic coupling between its windings and provides an energy storage mechanism in its core structure by including a discrete or distributed air gap or by using a magnetically permeable core material with a relatively low permeability capable of storing magnetic energy.

The coupled inductor 305 is effectively both an inductor and a transformer. The coupled inductor 305 may be a flyback transformer. The coupled inductor 305 contains intrinsic uncoupled inductance components 306 and 307. These uncoupled inductance components 306 and 307 are known to skilled practitioners as leakage inductances. A dotted terminal of the primary winding of coupled inductor 305 connects to a first terminal of a switch 320c. A negative terminal of the rectifier module 214 connects to a negative terminal of input capacitor 315d, to a negative terminal of a bulk energy storage capacitor 315a and to a second terminal of switch 320c. Bulk energy storage capacitor 315a is usually a relatively large electrolytic type capacitor having sufficient energy storage capability to power a load 250 when the input AC source 212 is insufficient to power the load 250. The bulk energy storage capacitor 315a is usually sufficiently large that it can power the load 250 when the input AC source 212 is insufficient with a voltage change over a line frequency cycle that is a small fraction of the peak voltage applied to bulk energy storage capacitor 315a. The criteria for selection of bulk energy storage capacitor 315a are known to skilled practitioners.

A positive terminal of bulk energy storage capacitor 315a is connected to a first terminal of a switch 320d. A second terminal of switch 320d is connected to the first terminal of switch 320c. The elements described so far are elements of a primary circuit network. All of the elements having a direct current path to the primary winding of the coupled inductor 305 are elements of the primary circuit network. The remaining components all have a direct current path to a secondary winding of coupled inductor 305 and are parts of a secondary circuit network. A dotted terminal of the secondary winding of coupled inductor 305 is connected to a positive terminal of a flyback capacitor 315b. An undotted terminal of the secondary winding of coupled inductor 305 is connected to a cathode of a rectifier diode 320b, to a positive terminal of an output capacitor 315c and to a first terminal of a load 250. A negative terminal of output capacitor 315c is connected to a first terminal of a switch 320a and to a second terminal of a load 250. An anode terminal of rectifier diode 320b is connected to a negative terminal of flyback capacitor 315b and to a first terminal of switch 320a.

There are two operating states. Between the two operating states there are brief switching intervals in which the switches 320a, 320c, and 320d change ON/OFF states. The time duration of the switching intervals is typically a small fraction of the time duration of the operating states. In a first operating state switch 320c is ON. At the beginning of the first operating state switch 320a is also ON. During the first operating state current in the primary winding of the coupled inductor 305 ramps up, and the stored energy increases in the coupled inductor 305. At the same time a current is induced in the secondary winding of coupled inductor 305. The secondary winding current flows into the positive terminal of output capacitor 315c, to the load 250, through switch 320a, and through flyback capacitor 315b. During the first operating state, flyback capacitor 315b is discharged while output capacitor 315c is charged. At a time determined by a control circuit, switch 320a turns OFF. The timing of the turn OFF of switch 320a is set by the control circuit to regulate a load 250 parameter, such as the load 250 voltage or the load 250 current. When switch 320a turns OFF, energy stored in uncoupled inductance components 306 and 307 forces the switch 320a voltage to rise. The switch 320a voltage may be clamped with a clamp diode 330. At a time determined by the control circuit to regulate the input current, switch 320c also turns OFF. Switch 320c always turns OFF at the same time as, or subsequent to, the turn OFF of switch 320a.

When switch 320c turns OFF, energy stored in coupled inductor 305 drives the voltage at the first terminal of switch 320c HIGH until the voltage across switch 320d is zero, at which time switch 320d turns ON. During the turn OFF transition of the switch 320d, the dotted terminals of the windings of the coupled inductor 305 become positive with respect to the undotted terminals of the windings. In the secondary circuit network the rectifier diode 320b becomes forward biased. During a second operating state switch 320d and rectifier diode 320b are in their ON states and the other switches 320a and 320c are OFF.

Initially current flows through the primary winding into the bulk capacitor 315a as current begins to ramp up in the secondary winding, charging the flyback capacitor 315b. During the second operating state the bulk capacitor 315a current falls, reverses direction, and rises in the direction opposite to its direction at the beginning of the second operating state. At a time determined by a control circuit, switch 320d turns OFF, and the stored energy in uncoupled inductance components 306 and 307 forces the switch 320d voltage to rise and forces the voltage on switch 320c to drop towards zero volts. When the switch 320c voltage reaches zero volts, it turns ON without incurring switching losses. When the current in the secondary winding of coupled inductor 305 drops to zero, the rectifier diode 320b turns OFF, and the voltage transition in the secondary circuit begins. The transition ends when switch 320a turns ON at zero volts. When switch 320a turns ON, the first operating state begins again and the cycle repeats.

The voltage output from the rectifier module 214 that is applied to the input capacitor 315d varies considerably during a line frequency cycle. When the magnitude of the voltage output is relatively large, near the peak of the AC line voltage, net charge flows into the bulk capacitor 315a during each switching cycle and the stored energy in bulk capacitor 315 increases. When the magnitude of the AC line voltage (input AC source 212) is near zero volts, net charge flows out of the bulk capacitor 315a and energy from the bulk capacitor 315a transfers to the flyback capacitor 315b through the coupled inductor 305 during the second operating state. During the first operating state, energy from the flyback capacitor 315b is transferred to the output capacitor 315c and the load 250. In order to maintain high power factor the current drawn from the input AC source 212 must be near zero when the input AC source 212 voltage is near zero. During the ON time of switch 320c, current is drawn from the rectifier 214 output while switch 320a is ON, and the output capacitor 315c is charged to power the load 250. When the rectifier 214 output voltage is LOW, current flows to the AC line during the ON time of switch 320d so that the net current drawn from the line is near zero. The minimal amount of energy drawn from the bulk capacitor 315a during the ON time of switch 320d must be equal to the energy needed by the load 250 for a full switching cycle.

When the input AC source 212 is LOW and switch 320d is ON, the voltage applied to the coupled inductor 305 windings is relatively large and energy can build up quickly, and current can ramp up quickly in the coupled inductor 305 windings and flyback capacitor 315b. This may be important because, when the input AC source 212 is near zero, the duty cycle of switch 320c is near one hundred percent, and the ON time of switch 320d is small. A control circuit that has a maximum duty cycle and minimum OFF time for the main switch will solve the problem. Many commercially available control integrated circuits have the feature of maximum duty cycle and minimum OFF time. When the input AC source 212 is zero during the ON time of switches 320a and 320c, the coupled inductor 305 winding voltage is determined primarily by the difference in voltage between the flyback capacitor 315b voltage and the output capacitor 315c voltage, where the flyback capacitor 315b voltage is larger than the output capacitor 315c voltage.

During operation the assumption is made that the ON time for switch 320c is equal to or greater than the ON time for switch 320a, thereby guaranteeing that the load 250 receives sufficient energy over the full line cycle. This condition can be detected and the error voltage for the outer voltage loop for the line current regulator (PFC module 220) can be increased if the ON time for switch 320c becomes equal to the ON time for switch 320a. If the error voltage for the outer voltage loop is increased, then the bulk capacitor 315a voltage will increase and the ON time of switch 320a will be reduced. A control method that is sensitive to net line current such as average current mode control or charge control is recommended for this embodiment. The desired result of near zero net line current while simultaneously providing all of the energy needed by the load 250 each cycle is achieved when the PFC module 220 is near zero.

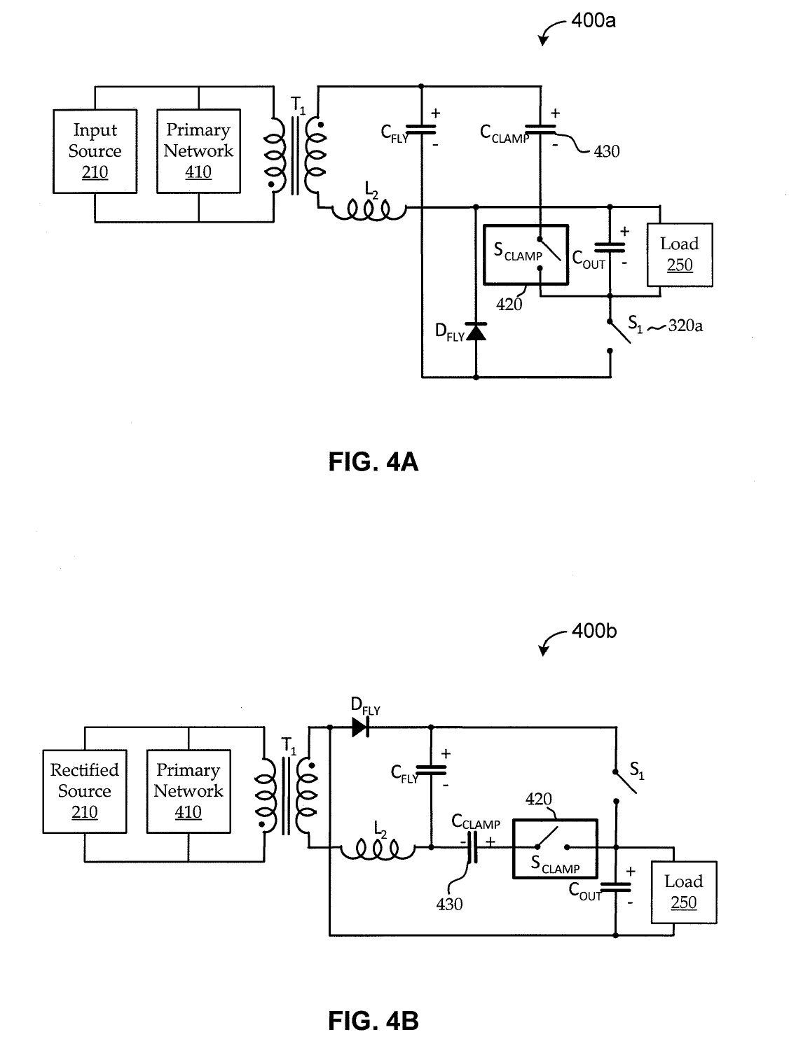

It is worth noting that many other embodiments are possible. For example, the embodiment in FIG. 3B is similar to the embodiment in FIG. 3A except that the relative positioning of switch 320a in relation to the output capacitor 315c and the load 250 is reversed. FIG. 4A and FIG. 4B illustrate additional embodiments similar to the embodiments in FIG. 3A and FIG. 3B, respectively. The embodiments in FIG. 4A and FIG. 4B replace the clamp diode 330 with a clamp switch 420 so that the clamped energy can be re-circulated rather than dissipated. Adding a clamp capacitor 430 in series with the clamp switch 420 can eliminate ringing when switch 320a turns OFF.

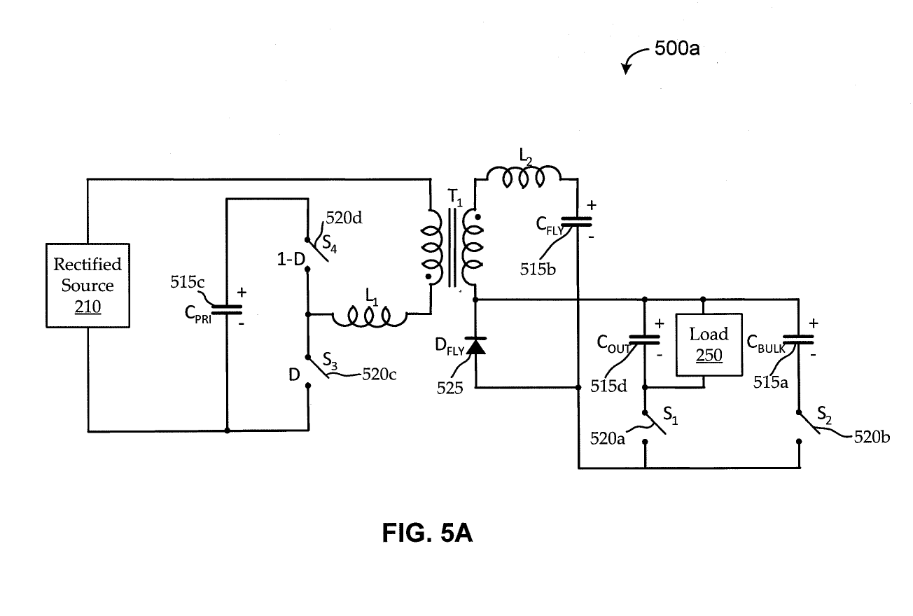

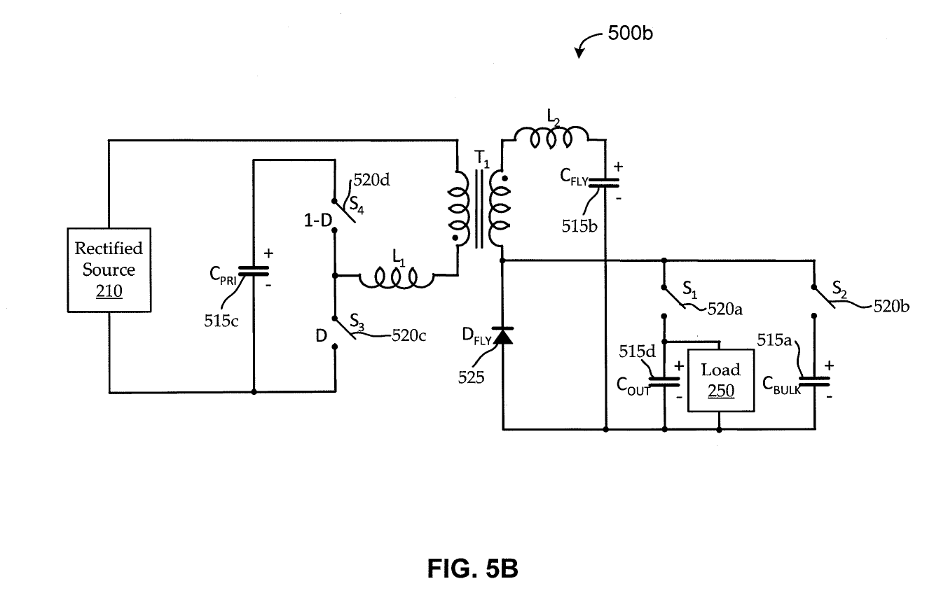

Notably, some embodiments may allow certain clamping elements (e.g., the clamp diode 330 of FIGS. 3A and 3B, the clamp switch 420 and clamp capacitor 430 of FIGS. 4A and 4B, etc.) to be removed without degrading performance. For example, the embodiments in FIG. 5A and FIG. 5B provide functionality similar to clamping by placing the bulk energy storage capacitor 515a in the secondary circuit as a second unloaded higher voltage output. During the first operating state, switches 520a and 520c are initially ON. When the output capacitor 515d is fully replenished, switch 520a turns OFF and switch 520b turns ON until the switches 520b and 520c are turned OFF simultaneously at the end of the first operating state.

At high AC line voltages near the peak of the AC line voltage, net charge flows into the bulk capacitor 515a during each cycle. As the line voltage falls, less net charge transfers to the bulk capacitor 515a during each cycle. When the AC line voltage is lower than its root-mean-squared (RMS) value, net charge flows out of the bulk capacitor 515a so that at the end of the switch 520b and 520c ON time, the current is reversed in the bulk capacitor 515a and in switch 520b. As the AC line voltage approaches zero, the current in switch 520b will reverse towards the end of its ON time. During the second operating state, when the AC line voltage is near zero, the primary capacitor 515c does not need to replenish the flyback capacitor 515b because the flyback capacitor 515b will have already been replenished by the bulk capacitor 515a during the first operating state when the bulk capacitor 515a was discharging.

A feature of the embodiments of FIG. 5A and FIG. 5B is that inrush current at power up is reduced due to the secondary side placement of the bulk energy storage capacitor 515a, eliminating the need for a current limiting device or circuit. Another feature is that no secondary clamping circuit is needed to eliminate or clamp ringing after turning OFF switch 520a. One limitation may be that the control scheme is complicated because the line current is negative and increasing in magnitude at the end of the first operating state for AC line voltages near zero. Another limitation may be that a larger and costlier bulk energy storage capacitor 515a may be required if the load 250 voltage is much lower than the primary capacitor 515c voltage, since the energy storage density of capacitors increases with voltage rating.

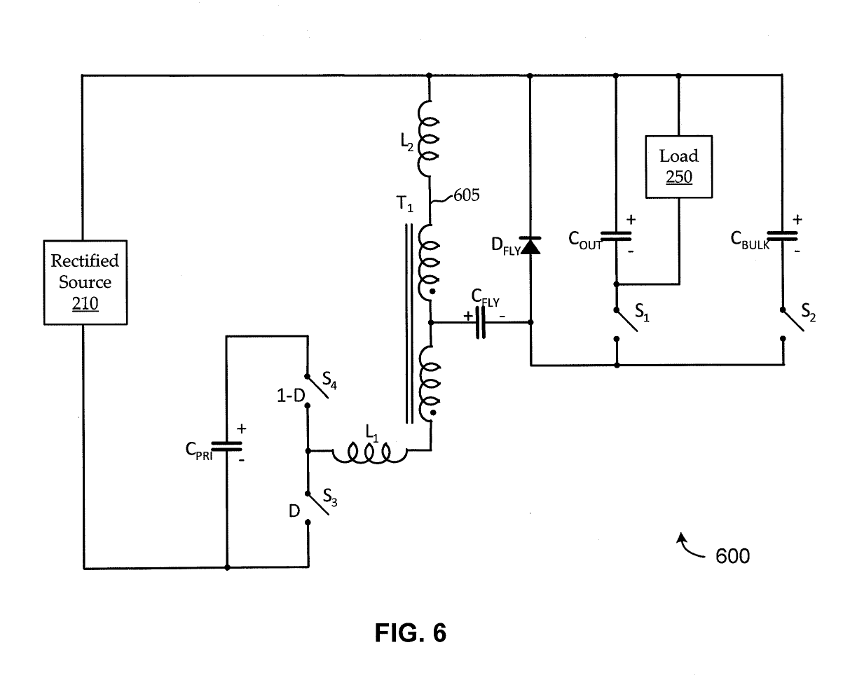

FIG. 6 illustrates another embodiment similar to the embodiment in FIG. 5A. The embodiment in FIG. 6 uses a tapped inductor in which the secondary winding is formed from a section of the primary winding. The RMS current in the winding common to primary and secondary circuit networks is reduced in comparison to the secondary current in the isolated previously described embodiments so that the coupled inductor 605 will be more efficient and can be made smaller than the coupled inductors of the previously described embodiments for isolated applications.

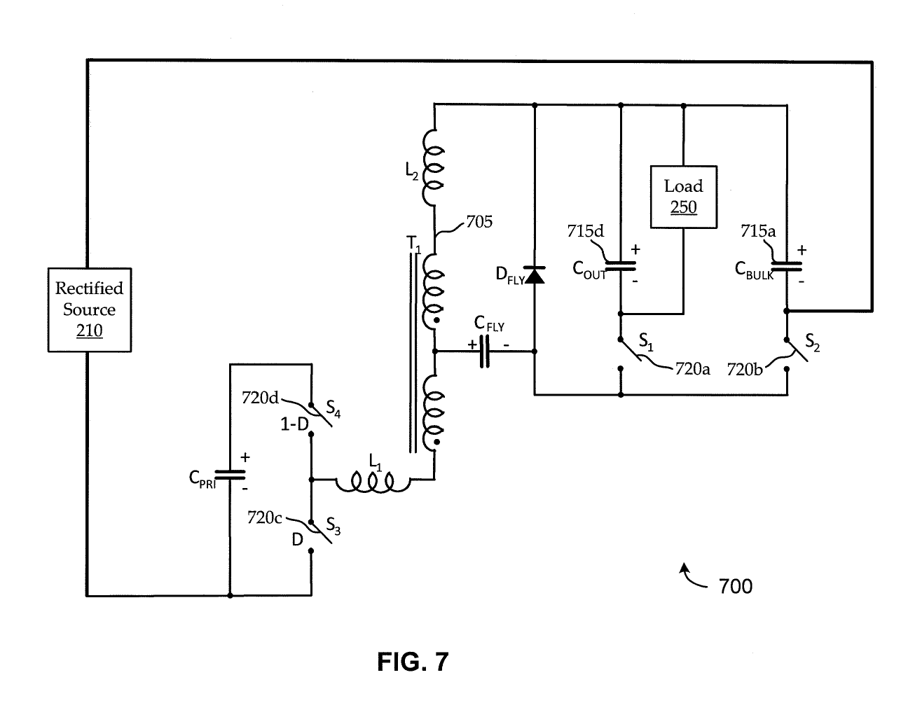

FIG. 7 illustrates an embodiment similar to the FIG. 6 embodiment, but with the bulk capacitor 715a connected in series with the line so that the primary winding voltage will have a minimum value during the first operating state over a line cycle, and the duty cycle will have a maximum value over a line cycle. During the first operating state, switch 720a conducts until the output capacitor 715d is replenished. Switch 720a then turns OFF, and switch 720b turns ON, initially charging bulk capacitor 715a. When the AC line voltage is near its peak, net energy transfers to bulk capacitor 715a. When the AC line voltage is near its zero crossover, net energy transfers from bulk capacitor 715a to coupled inductor 705 and the load 250. At the AC crossover, current flows from the line while the output capacitor 715d is charged during the switch 720a ON time and current flows to the line shortly after switch 720b turns ON. The timing of the switches can provide for near zero net line current near the AC crossover. The control near the AC crossover is complicated by the fact that increasing the ON time of switches 720b and 720c reduces the average line current since the line current is negative but increasing in magnitude at the time that switches 720b and 720c turn OFF.

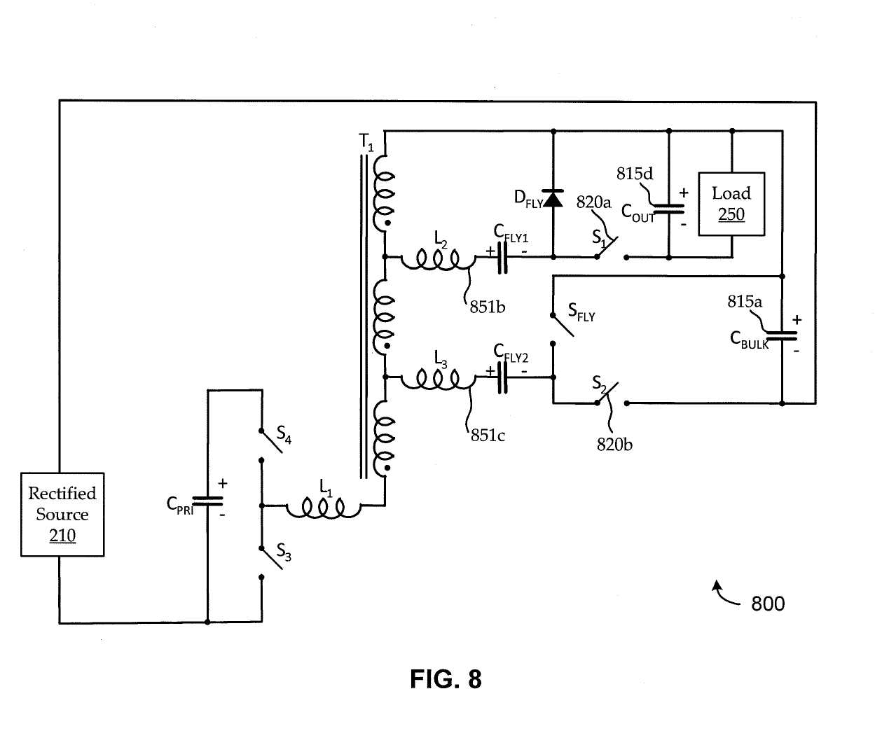

FIG. 8 illustrates an embodiment similar to the embodiment of FIG. 7, except that the bulk energy storage capacitor 815a is provided with its own winding tap 851c separate from the winding tap 851b provided for the output. The operation is similar to that described above for the embodiment of FIG. 7. The benefits of providing the bulk energy storage capacitor 815a with its own winding tap 851b are that a higher voltage bulk capacitor 815a can be used having higher energy storage density, and the separate tap arrangement enables a condition in which switches 820a and 820b can have overlapping conduction, which enables energy to be transferred to the output capacitor 815d more rapidly.

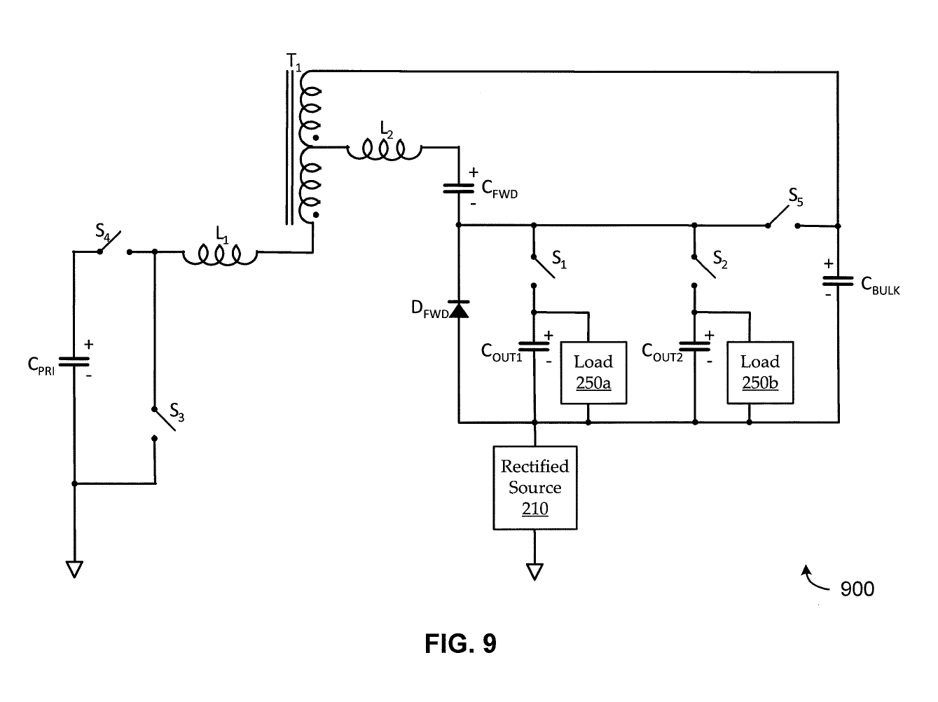

FIG. 9 illustrates another embodiment that is similar to the embodiment of FIG. 7, except that the FIG. 9 embodiment has two independently regulated outputs 250a and 250b, and the relative positions of switches and capacitors are reversed relative to the positions illustrated in the FIG. 7 embodiment.

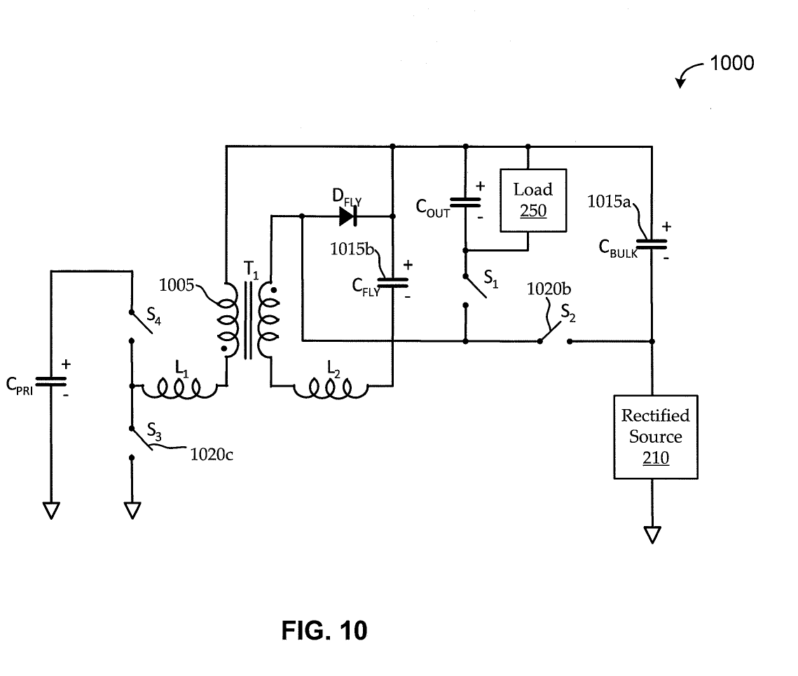

FIG. 10 illustrates an embodiment similar to the embodiment of FIG. 5A, but with bulk capacitor 1015a connected in series with the rectified source 210. The primary winding voltage has a minimum value equal to the bulk capacitor 1015a voltage so that more time is available to replenish the charge in the flyback capacitor 1015b during the second operating state. The minimum primary winding voltage suggests that the switch 1020c duty cycle will not try to approach 100% when the AC line voltage is near a zero crossing. The minimum primary winding voltage also means that there will be a non-zero magnetizing current slope during the first operating state when switch 1020c is ON.

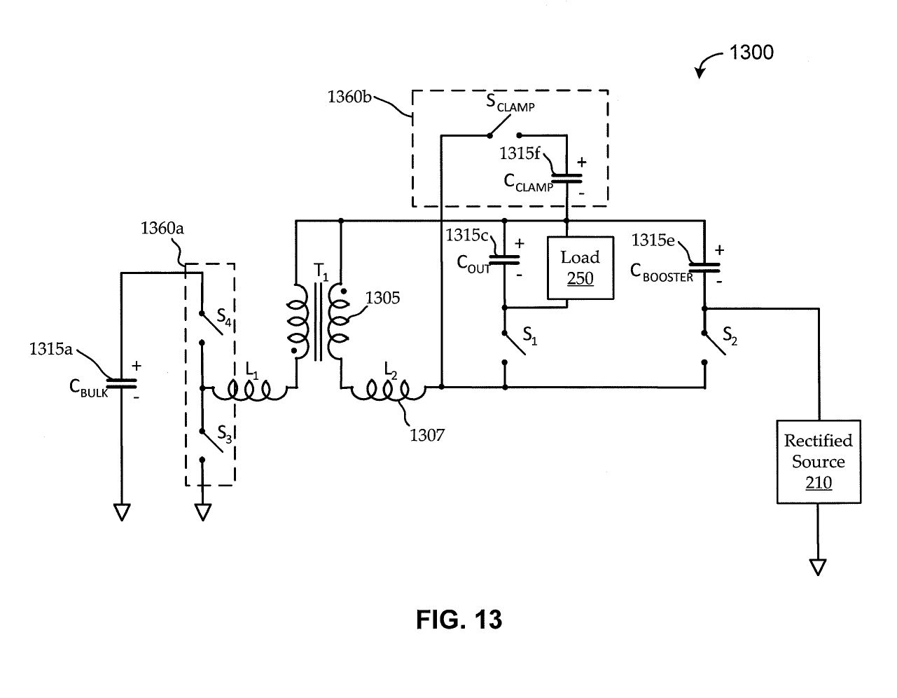

Over most of the AC line voltage range the operation is substantially the same as the FIG. 5A embodiment. At or near the AC crossover, the embodiment of FIG. 13 will enable the coupled inductor 1005 to build up more stored energy to be transferred to the flyback capacitor 1015b during the second operating state, compared to the embodiment of FIG. 5A. Near the AC crossover during the first operating state, the bulk capacitor 1015a initially will charge, but the current will reverse soon after switch 1020b turns ON. Most of the time that switch 1020b conducts, the bulk capacitor 1015a will be discharging, which induces a primary winding current into the dotted terminal of the primary winding so that current will flow into the line during part of the cycle and the net line current can be near zero, as desired for PFC.

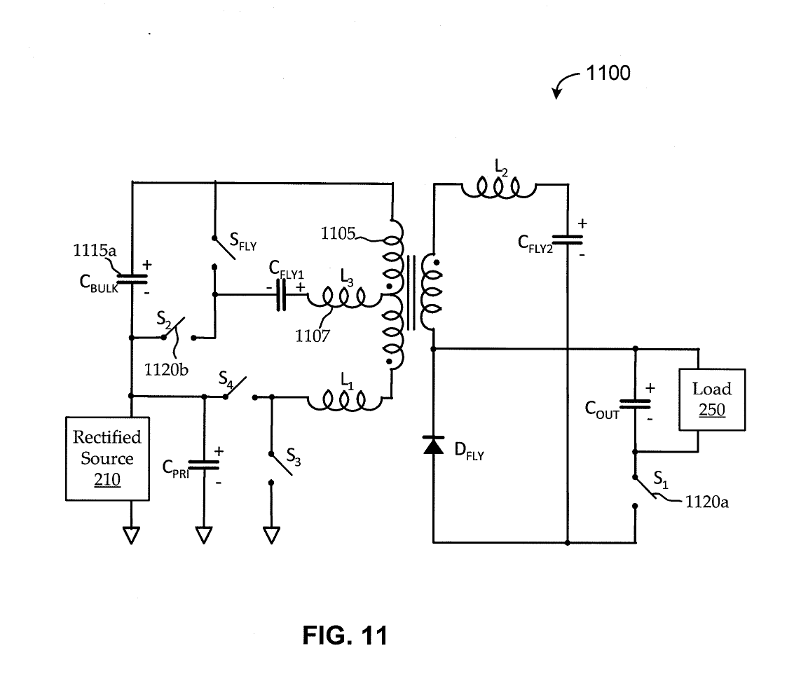

FIG. 11 is another embodiment similar to the FIG. 10 embodiment, except that a tertiary winding 1107 is added and connected to the primary circuit network. The separate windings are used to exchange energy with the load 250 and bulk energy storage capacitor 1115a while the output is isolated. This allows for altering the switch timing so that there can be some overlap between the switches 1120a and 1120b during the first operating state.

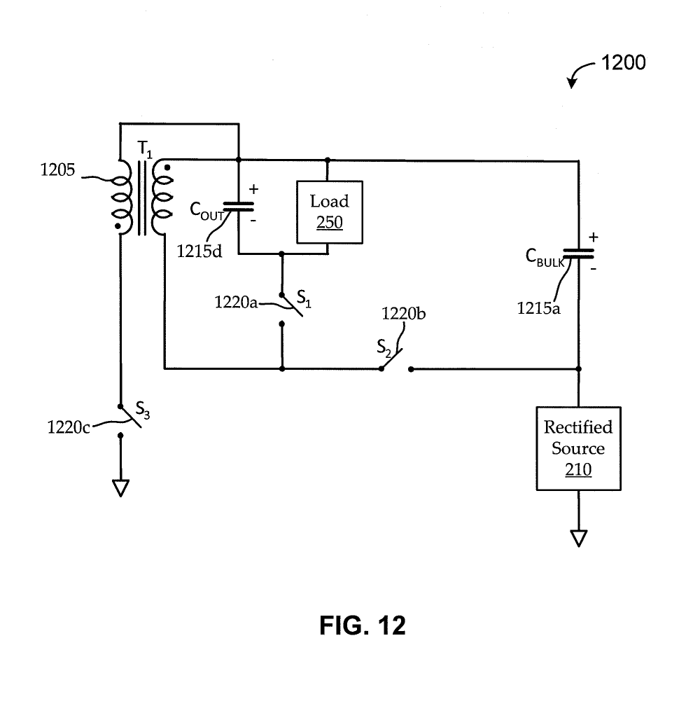

FIG. 12 illustrates a flyback embodiment, which also has two operating states. In a first operating state, switch 1220c is ON and current increases linearly in the primary winding of the coupled inductor 1205. At the end of the first operating state, current flows out of the dotted terminal of the primary winding of the coupled inductor 1205 and switch 1220c turns OFF. During the switching transition that follows the turn OFF of switch 1220c, the dotted terminals of both windings of the coupled inductor 1205 become positive with respect to the undotted terminals of the windings. At the end of the switch 1220c turn OFF transition, switch 1220a turns ON at zero voltage.

During a second operating state, energy stored in the coupled inductor 1205 is transferred to the output capacitor 1215d and to the load 250. At a time determined by the control circuit to precisely regulate a load 250 parameter, switch 1220a is turned OFF. When switch 1220a turns OFF, stored energy in the coupled inductor 1205 forces the dotted terminal of the windings to become more positive with respect to the undotted terminals of the windings until the switch 1220b voltage is zero, at which time switch 1220b turns ON. When switch 1220b is ON, energy transfers between the coupled inductor 1205 and the bulk energy storage capacitor 1215a. At first, energy transfers from the coupled inductor 1205 to the bulk capacitor 1215a, then the current reverses and energy transfers from the bulk capacitor 1215a to the coupled inductor 1205. When switch 1220b turns OFF, energy in the coupled inductor 1205 drives the switch 1220c voltage to zero, at which time switch 1220c turns ON. When the AC line voltage is near its peak, net energy transfers to the bulk capacitor 1215a and its voltage rises. When the AC line voltage is near zero, energy transfers from the bulk capacitor 1215a to the coupled inductor 1205 and a larger current into the dotted terminal of the secondary winding is created. If the energy in the coupled inductor 1205 at the time that switch 1220c turns ON is equal to the energy in the coupled inductor 1205 at the end of the first operating state when switch 1220c turns OFF, then the net line current is zero.

During the first operating state when the AC line voltage is near zero, the primary winding current begins flowing into the dotted terminal of the primary winding. During the first operating state, the switch 1220c current grows increasingly more positive, reaches zero, and ramps up to a level at which the energy in the coupled inductor 1205 is sufficient to fully replenish the output capacitor 1215d and provide the energy delivered to the load 250 during a full switching cycle. At near-zero AC line voltages, the energy stored in the coupled inductor 1205 at the end of the first operating state is only slightly larger than the energy stored in the coupled inductor 1205 at the end of the second operating state, but the magnetizing currents in the coupled inductor 1205 are reversed from each other at the ends of the two operating states. At AC line voltages near zero, the voltage applied to the primary winding during the first operating state is equal to the bulk energy storage capacitor 1215a voltage. The non-zero primary winding voltage when the AC line voltage is zero provides for the ability of the current to ramp positive over time at all line conditions and enables the operation described above.

FIG. 13 illustrates another embodiment related to the FIG. 12 embodiment. In the FIG. 13 embodiment, the effects of leakage inductance are dealt with directly by adding active clamp networks 1360a and 1360b to both line side and load side circuit networks to clamp both windings during both operating states and eliminate all leakage inductance induced ringing. Leakage inductance energy in this embodiment is fully clamped.

Another difference between the FIG. 13 embodiment and the FIG. 12 embodiment is that, in the FIG. 13 embodiment, the bulk energy storage capacitor 1315a is placed in the active clamp network for the primary winding and there is a booster capacitor 1315e placed in series with the line to provide a minimum primary winding voltage during the first operating state. During the second operating state, energy first transfers into the bulk capacitor 1315a from the coupled inductor 1305, and then transfers out of the coupled inductor 1305 and out of the bulk capacitor 1315a into the output capacitor 1315c and the load 250 as current ramps up in the series inductance 1307. At the end of the second operating state, energy transfers from the bulk capacitor 1315a to the booster capacitor 1315e. During the first operating state, energy transfers into and then out of the clamp capacitor 1315f and energy transfers out of the booster capacitor 1315e to the coupled inductor 1305.

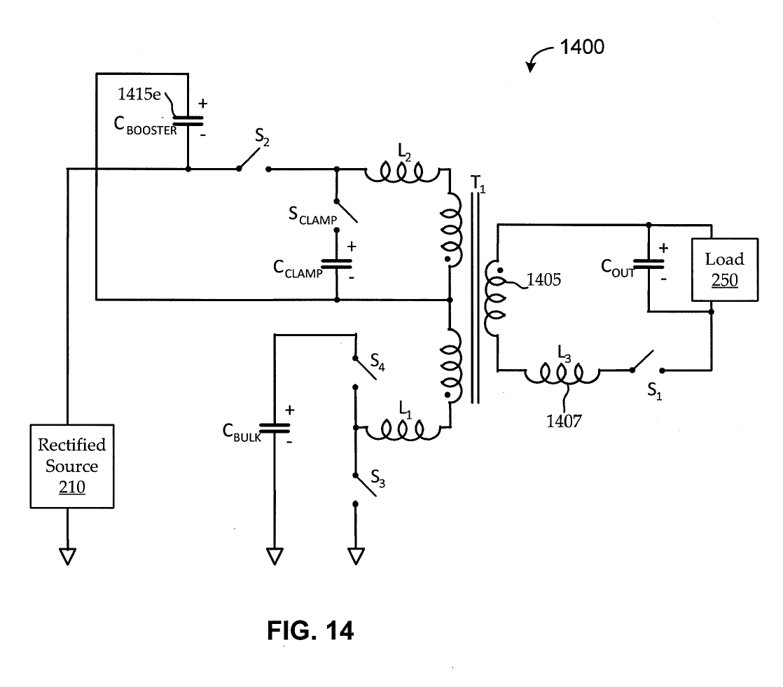

FIG. 14 illustrates an embodiment similar to the FIG. 13 embodiment in which a tertiary winding 1407 is added to the coupled inductor 1405 for separately accommodating the booster capacitor 1415e and for providing a separate fully isolated load network connected to the secondary winding.

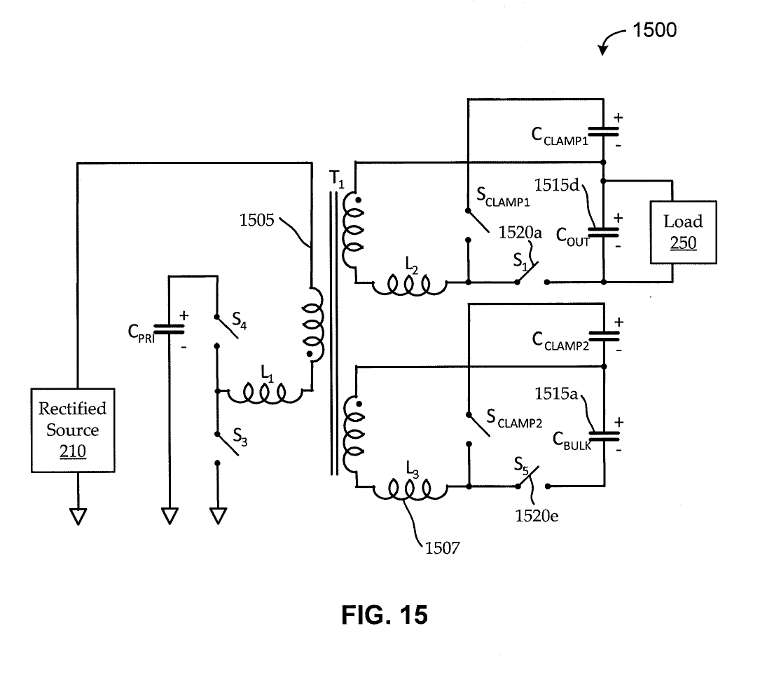

FIG. 15 illustrates another embodiment having a tertiary winding 1507 for the bulk energy storage capacitor 1515a but without a booster capacitor. This may effectively obviate an inrush current limiting circuit or circuit element by placing the bulk capacitor 1515a in a secondary circuit. This allows for overlapping operation of switch 1520a and switch 1520e during the second operating state. This is especially beneficial at or near the AC crossover where the duty cycle is large and the rate that energy can be built up in the coupled inductor 1505 during the first operating state is LOW. Near the AC crossover, the magnetizing current in the coupled inductor 1505 flows into the dotted terminals of the windings.

During the second operating state when switch 1520a and switch 1520e are both ON, current flows in the winding connected to the bulk capacitor 1515a and induces a current in the output capacitor 1515d to charge the output capacitor 1515d quickly. When switch 1520a turns OFF, switch 1520e can remain ON and induce current out of the line to balance the current that will flow into the line during the first operating state due to the negative magnetizing current to achieve near zero net line current.

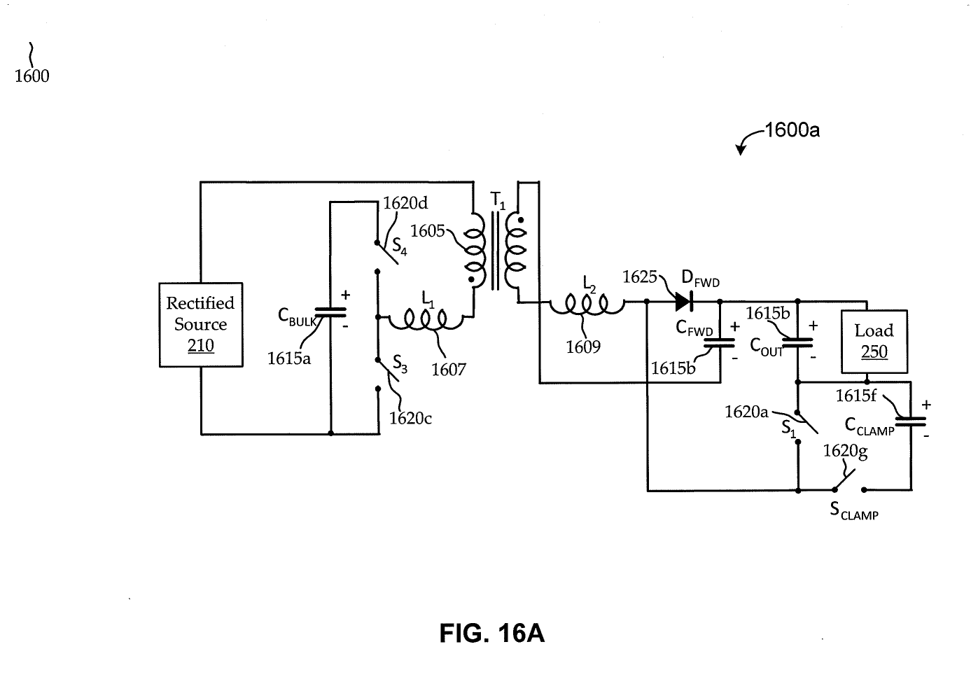

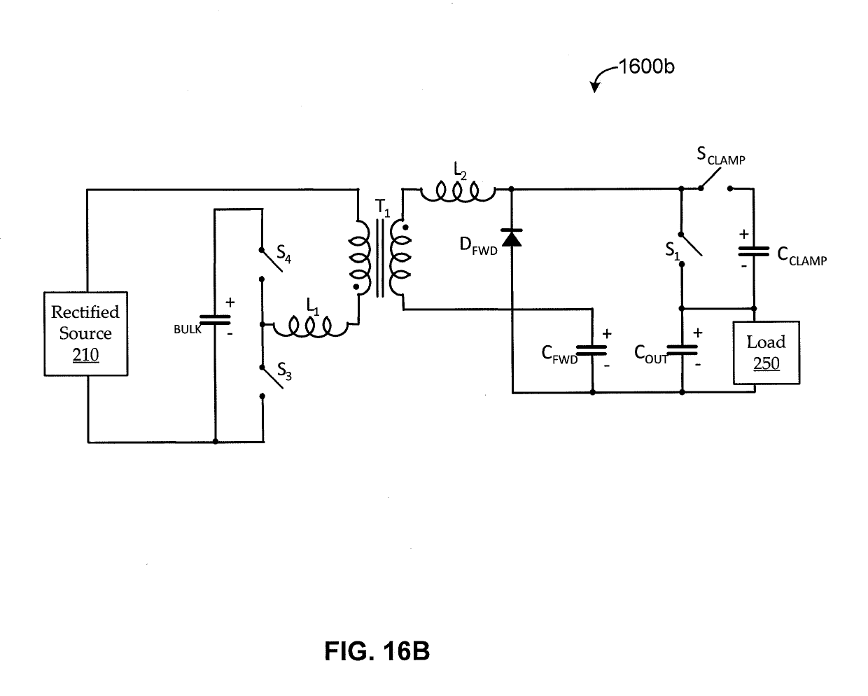

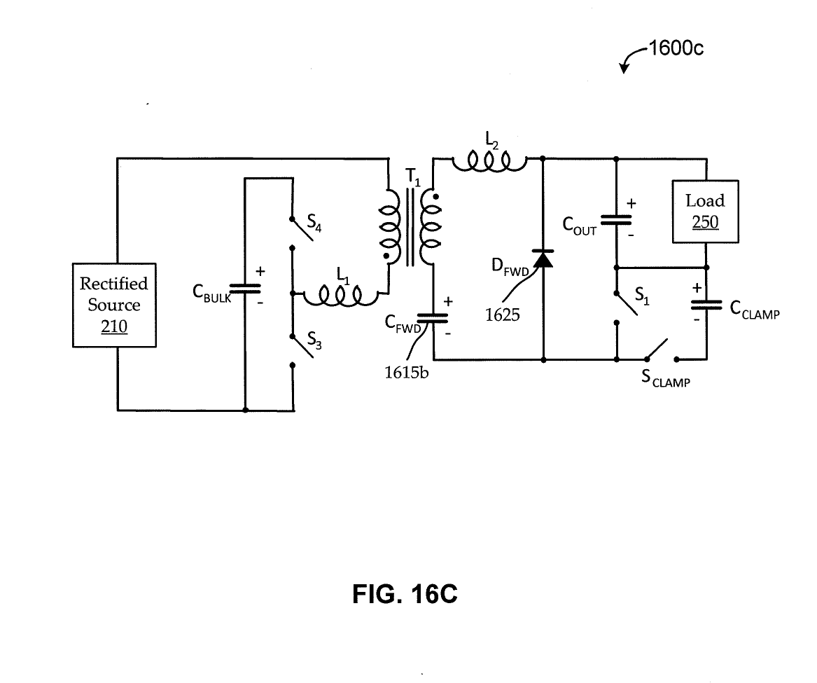

FIG. 16A illustrates a coupled inductor boost embodiment in which there are two operating states. In a first operating state, switch 1620c is ON and forward diode 1625 is forward biased. During the first operating state, magnetizing current ramps up in the primary winding of the coupled inductor 1605. An additional component of the primary winding current exists that induces a current in the secondary winding of the coupled inductor 1605, charging the forward capacitor 1615b to a voltage proportional to the line voltage with a constant of proportionality equal to the ratio of secondary turns to primary turns of the coupled inductor 1605. The first operating state ends when switch 1620c turns OFF.

A switching transition begins following the turn OFF of switch 1620c, wherein energy stored in inductor 1607, inductor 1609, and the coupled inductor 1605 forces the voltages at the dotted terminals of the coupled inductor 1605 windings to become positive with respect to the voltages at the undotted terminals of the coupled inductor 1605 windings. During the switch 1620c turn OFF, the switching transition current in inductor 1609 drops to zero and forward diode 1625 becomes reverse biased. At the end of the switch 1620c turn OFF transition, switch 1620a and switch 1620d turn ON at zero voltage.

In a second operating state, switch 1620d is ON and switch 1620a is initially ON. At a time determined by the control circuit to regulate a load parameter, switch 1620a turns OFF. When switch 1620a turns OFF, switch 1620g turns ON to capture the inductor 1609 current. With switch 1620g ON, the secondary winding of the coupled inductor 1605 is clamped, and energy passes to the clamp capacitor 1615f and the secondary current ramps down, reverses, and the clamp capacitor 1615f returns energy to the forward capacitor 1615b, the bulk capacitor 1615a, and the coupled inductor 1605. At the end of the second operating state, switch 1620d and switch 1620g turn OFF.

Stored energy in inductor 1609 forces the forward diode 1625 into conduction, and stored energy in the coupled inductor 1605 and/or inductor 1607 forces the voltages at the undotted terminals of the coupled inductor 1605 to become positive with respect to the voltages at the undotted terminals of the coupled inductor 1605 until switch 1620c turns ON at zero voltage. When switch 1620c turns ON, the cycle repeats. During a high AC line voltage condition, energy transfers from the coupled inductor 1605 into the bulk capacitor 1615a. During a low AC line voltage condition, energy transfers from the bulk capacitor 1615a into the coupled inductor 1605, and from the coupled inductor 1605 to the output capacitor 1615b and the load 250.

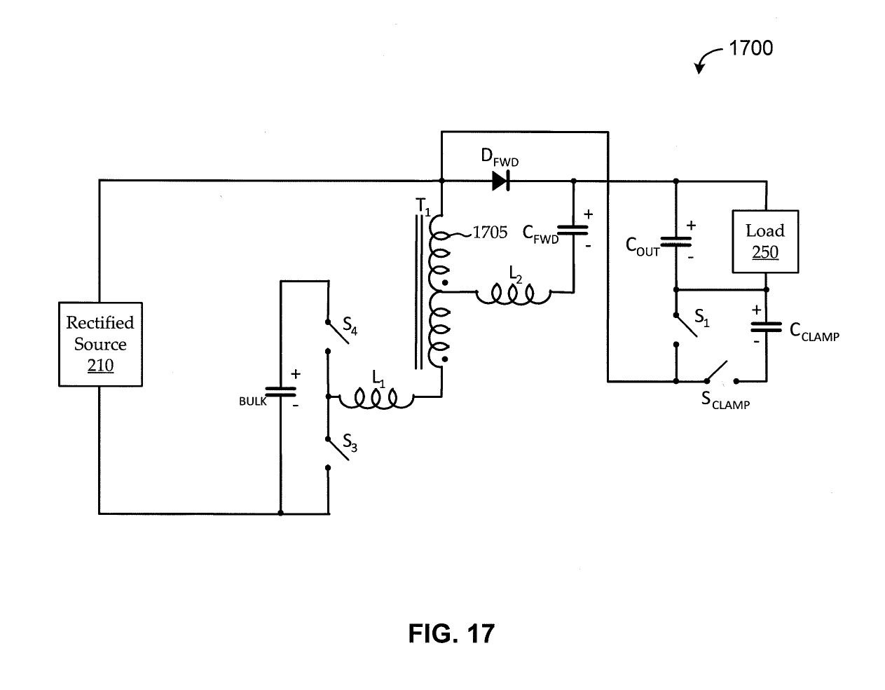

FIG. 16B illustrates an embodiment similar to the FIG. 16A embodiment in which the relative positions of capacitors and switches are reversed in the secondary network. FIG. 16C illustrates an embodiment similar to the FIG. 16A embodiment in which the relative positions of the forward diode 1625 and the forward capacitor 1615b are reversed. FIG. 17 illustrates an embodiment similar to the FIG. 16A embodiment in which the secondary winding of the coupled inductor 1705 is common with a section of the primary winding in a tapped inductor configuration. The tapped inductor configuration is a non-isolated arrangement, but it offers cost, size, and efficiency advantages over the FIG. 16A embodiment.

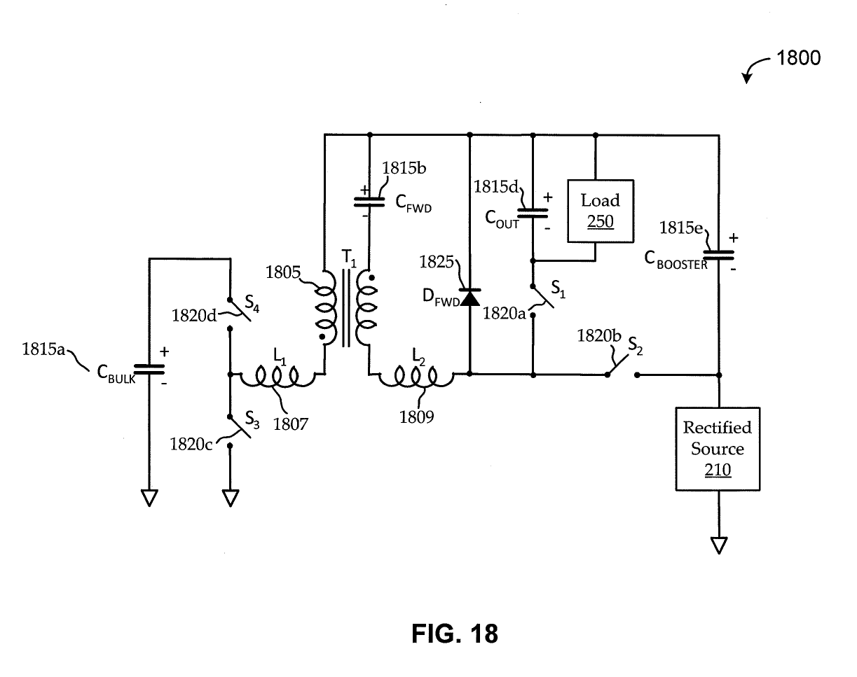

FIG. 18 illustrates a coupled inductor boost converter similar to the FIG. 16A embodiment that uses a booster capacitor 1815e according to various embodiments. In a first operating state with switch 1820c ON, current ramps up in the primary winding of the coupled inductor 1805 as the booster capacitor 1815e discharges. At the same time, a current is induced in the secondary winding which charges the forward capacitor 1815b through the forward diode 1825.

At the end of the first operating state, switch 1820c turns OFF and stored energy from inductor 1807, inductor 1809, and the coupled inductor 1805 force current into the bulk capacitor 1815a through switch 1820d. At the same time, the winding voltages reverse and the remaining energy in inductor 1809 transfers into the forward capacitor 1815b. In the near-zero AC line voltage condition the winding voltages are large, and the forward capacitor 1815b voltage is relatively small, so the current in the primary winding reverses soon after switch 1820d turns ON. At the same time, current rapidly ramps up in the secondary winding as the forward capacitor 1815b discharges into the output capacitor 1815d and the load 250.

In the near-peak AC line voltage condition, the forward capacitor 1815b voltage is relatively large and the winding voltages are relatively small, so the rate at which the current in inductor 1807 decreases is much less than the near-zero AC line voltage condition, and current continues to flow through switch 1820d into the bulk capacitor 1815a. At the same time, current ramps up in the secondary winding as the forward capacitor 1815b discharges into the output capacitor 1815d and the load 250 through switch 1820a. In the near-peak AC line voltage condition, the magnetizing current in the coupled inductor 1805 is much larger due to power factor correction so the initial current in inductor 1807 is much larger than in the near-zero AC line condition. The much higher magnetizing current and the forward capacitor 1815b voltage of the near-peak AC line voltage condition contributes to a fast rising current in the secondary winding. When the output capacitor 1815d has received enough energy to power the load 250 for a full switching cycle, switch 1820a turns OFF and switch 1820b turns ON, directing current into the booster capacitor 1815e. The booster capacitor 1815e is charged by the secondary circuit and by the bulk capacitor 1815a while switch 1820b is ON. When switch 1820d and switch 1820b turn OFF, the stored energy in inductor 1807 and inductor 1809 drives the switch 1820c switch voltage to zero volts, at which time switch 1820c turns ON and the cycle repeats.

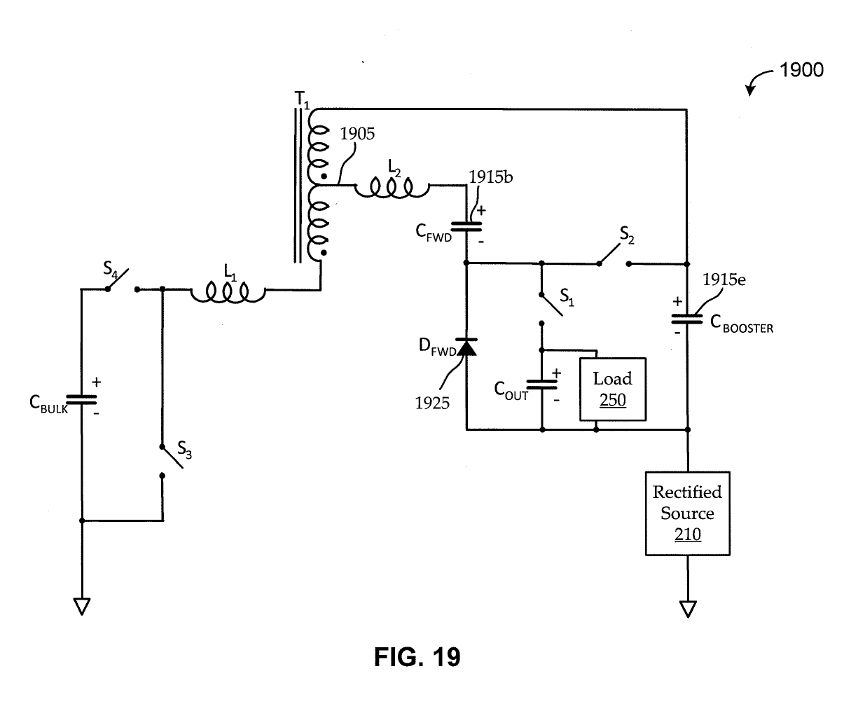

FIG. 19 illustrates an embodiment that operates in a manner almost identical to the FIG. 18 embodiment, except that it uses a tapped inductor 1905 wherein the secondary winding is formed from a section of the primary winding. The forward diode 1925 is not connected to the secondary winding, but is coupled to the secondary winding through the booster capacitor 1915e. The result of the altered diode connection alters the voltage applied to the forward capacitor 1915b. This embodiment may be able to utilize smaller, cheaper, and/or more efficient transformers for its operation than certain other embodiments.

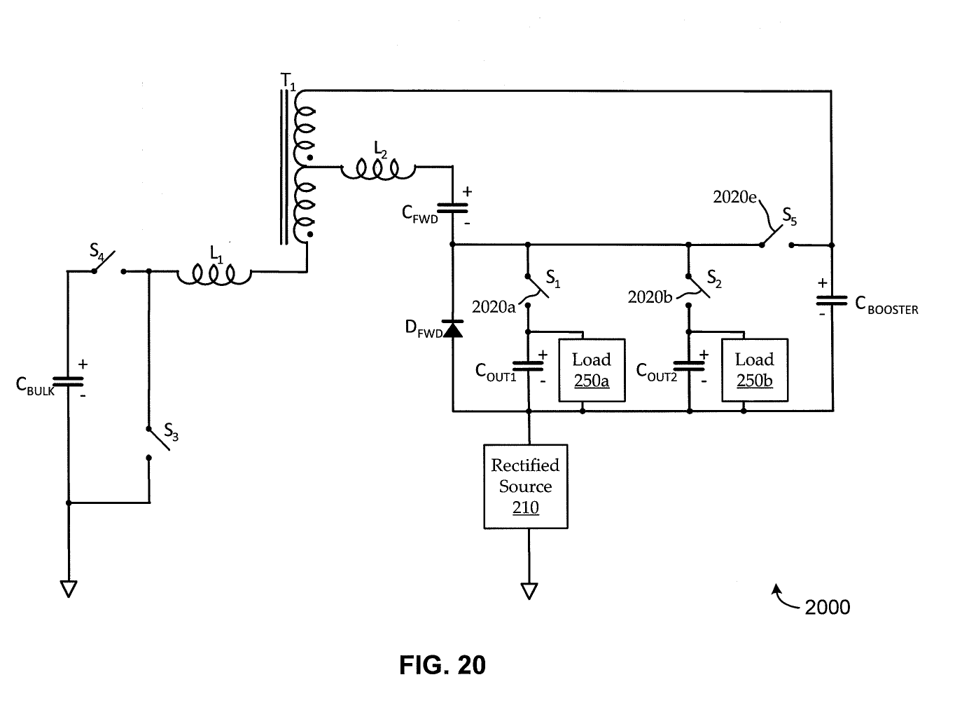

FIG. 20 illustrates another embodiment similar to the FIG. 19 embodiment, but with the addition of a second output 250b. During the first operating state, switch 2020a turns ON first, followed by switch 2020b, which turns ON when switch 2020a turns OFF, followed by switch 2020e when switch 2020b turns OFF. The ON times of switch 2020a and switch 2020b are controlled to regulate output parameters of first and second outputs, 250a and 250b, respectively.

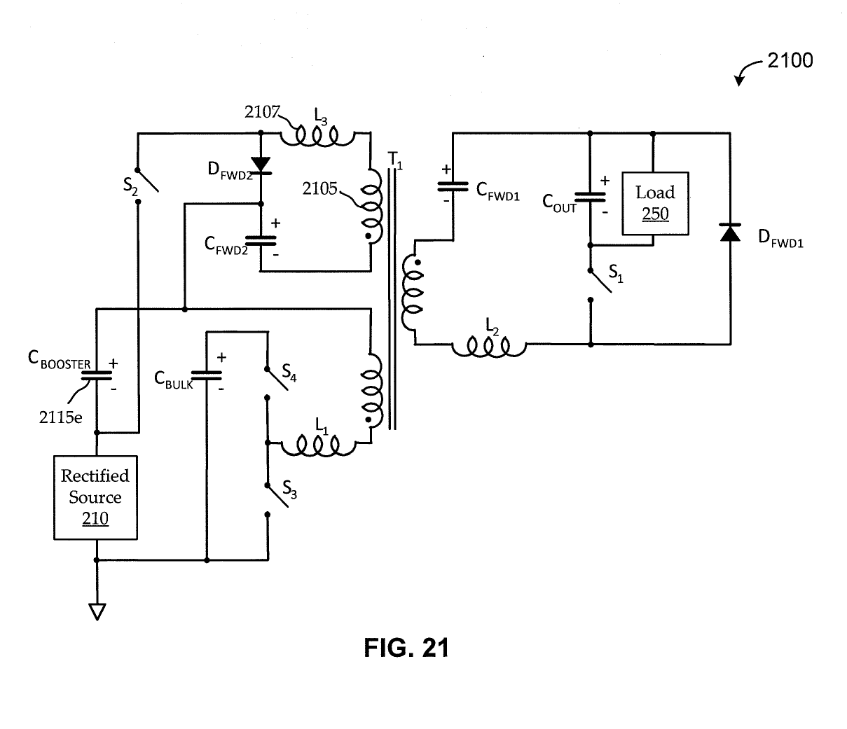

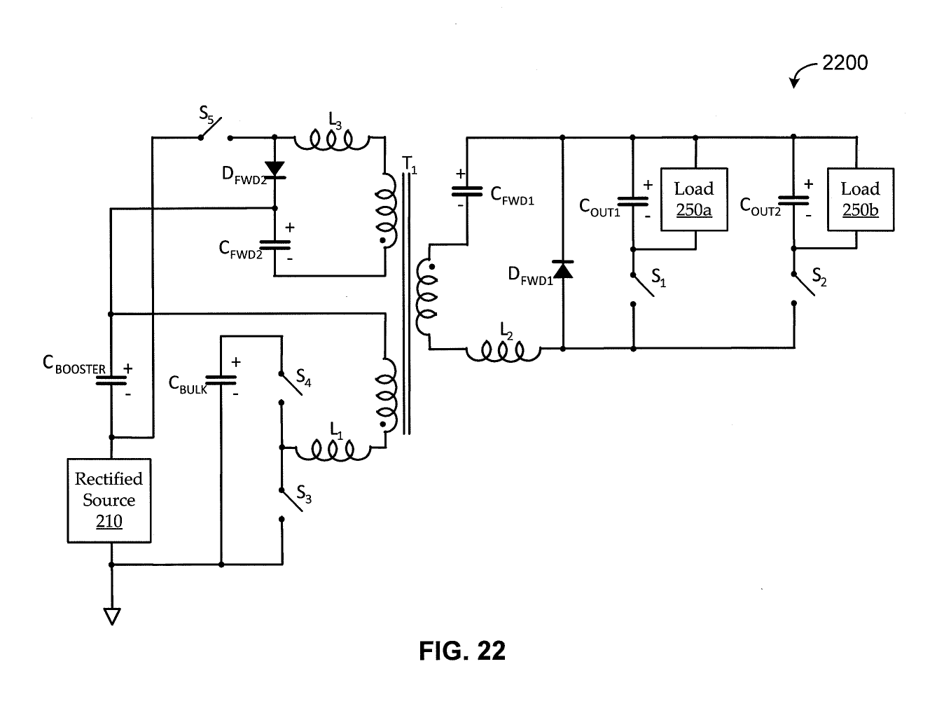

FIG. 21 illustrates another embodiment similar to the FIG. 18 embodiment but with an isolated output and a tertiary winding 2107 coupled to the coupled inductor 2105 for exchanging energy with the booster capacitor 2115e. FIG. 22 illustrates an embodiment similar to the FIG. 21 embodiment but with two independently regulated outputs 250a and 250b controlled in the manner described above for the FIG. 20 embodiment.

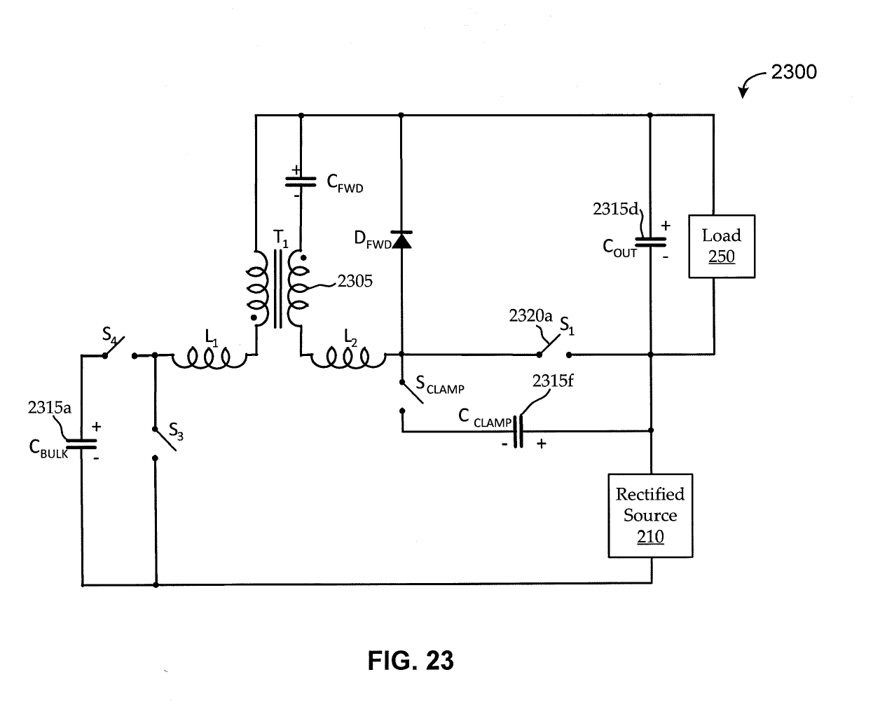

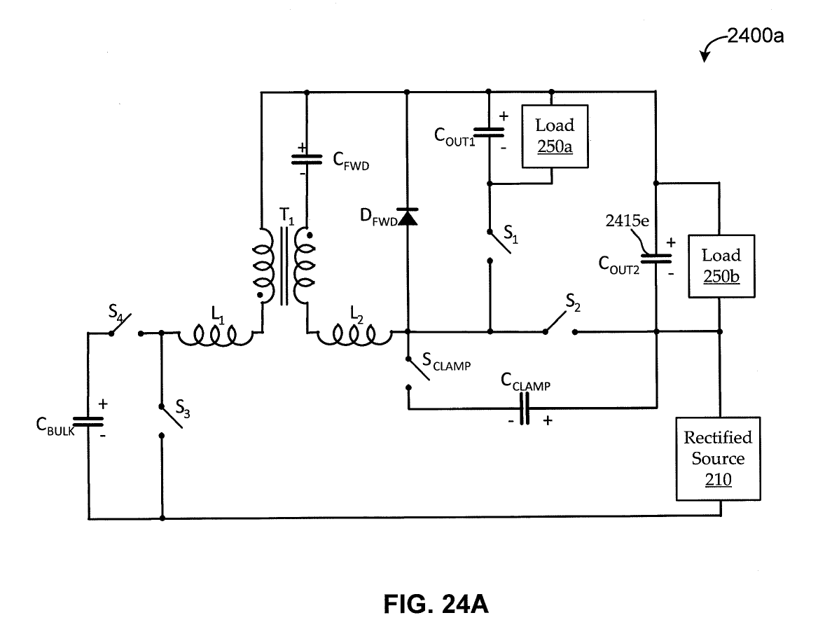

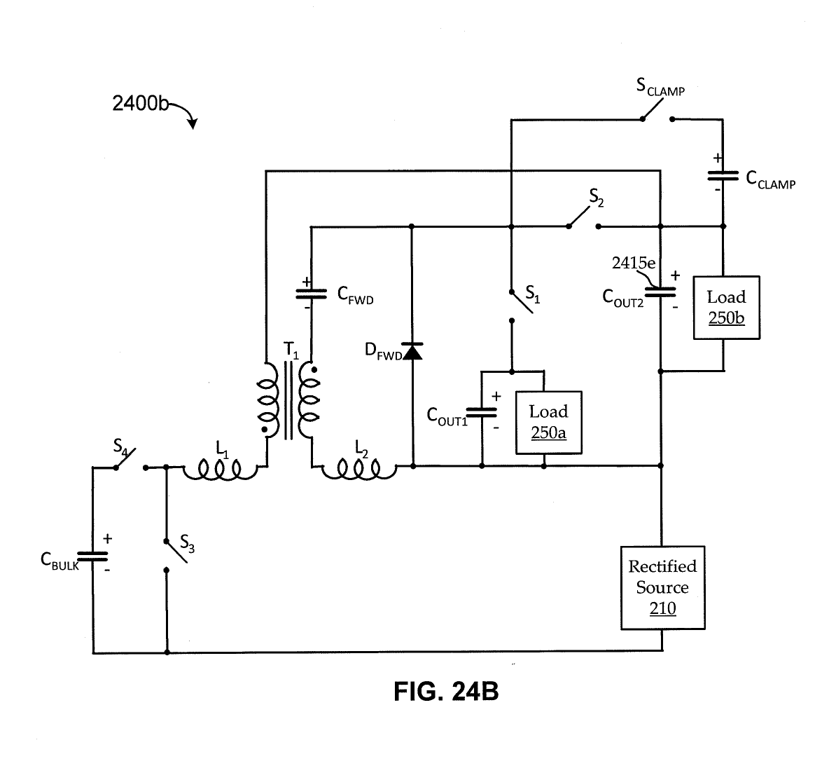

FIG. 23 illustrates another embodiment similar to the FIG. 18 embodiment wherein the output capacitor 2315d serves as a booster capacitor. During the first operating state, after switch 2320a turns OFF, the excess energy is transferred to the clamp capacitor 2315f and then transferred back out of the clamp capacitor 2315f to the coupled inductor 2305 and the bulk capacitor 2315a. The FIG. 24A embodiment is similar to the FIG. 23 embodiment except that FIG. 24A adds a second output 250b having a second output capacitor 2415e which serves as the booster capacitor. FIG. 24B is identical to the FIG. 24A embodiment except that relative positions of switches and output capacitors are reversed.

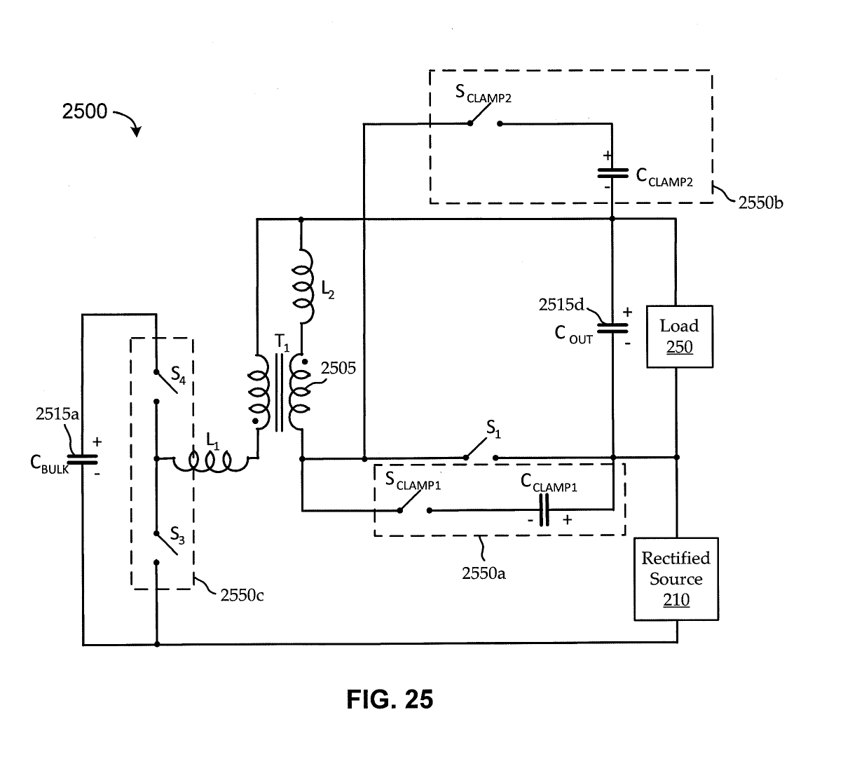

FIG. 25 illustrates an embodiment using a flyback implementation similar to the FIG. 12 embodiment but with several changes and additions. In this embodiment, the output capacitor 2515d serves as the booster capacitor. There are also three active clamp networks, 2550a, 2550b, and 2550c, provided for fully clamping the windings of the coupled inductor 2505 during both operating states, so that all leakage inductance induced ringing is eliminated. Also in this embodiment, the bulk energy storage capacitor 2515a is placed in the active clamp network for the primary winding.

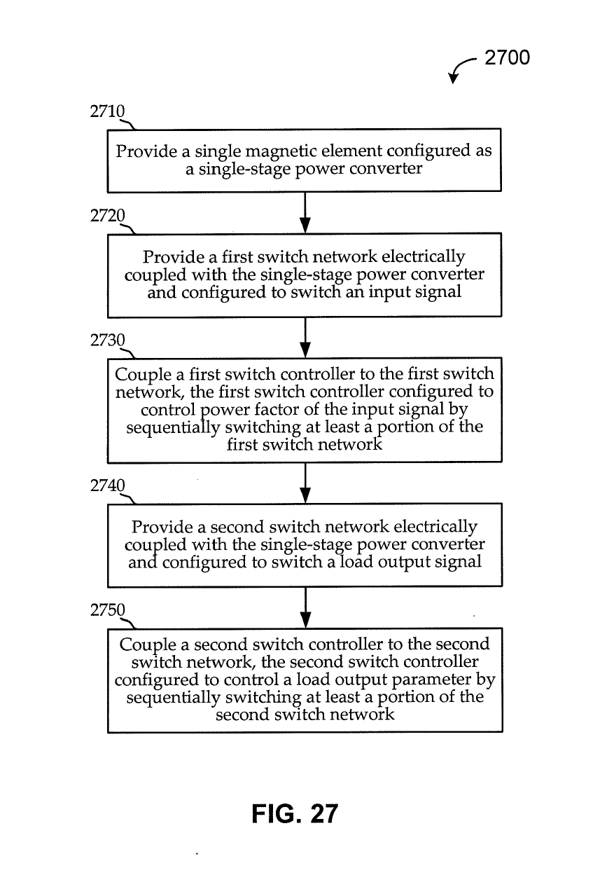

The embodiments described above are configured to achieve high power factor simultaneously with independently regulated outputs. For example, any of the above embodiments may be configured to perform the method 2700 of FIG. 27. The method 2700 begins at block 2710 by providing a single magnetic element configured as a single-stage power converter. At block 2720, a first switch network is electrically coupled with the single-stage power converter and configured to switch an input signal. At block 2730, a first switch controller is coupled to the first switch network, the first switch controller configured to control power factor of the input signal by sequentially switching at least a portion of the first switch network. At block 2740, a second switch network is electrically coupled with the single-stage power converter and configured to switch a load output signal. At block 2750, the second switch controller may be coupled to the second switch network, the second switch controller configured to control a load output parameter by sequentially switching at least a portion of the second switch network.

### Embodiments for Independent Regulation of Output Loads

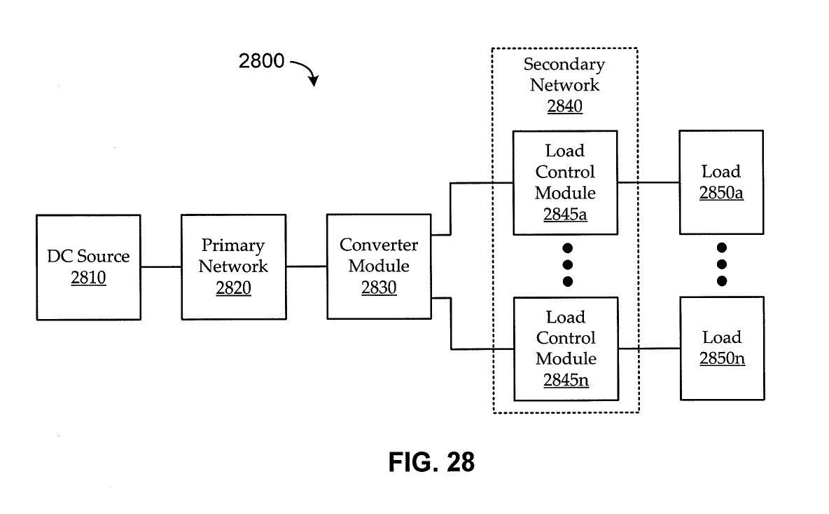

While embodiments described above are configured to achieve high power factor simultaneously with independently regulated outputs, other embodiments include novel circuit structures that simultaneously achieve multiple independently regulated outputs, without addressing high power factor. FIG. 28 shows a simplified block diagram of an illustrative circuit 2800 for providing independent output regulation, according to various embodiments.

The circuit 2800 includes a single magnetic element configured as a converter module 2830 (e.g., a flyback converter). One side of the converter module 2830 is coupled with a primary network 2820 and the other side of the converter module 2830 is coupled with a secondary network 2840. Each of the primary network 2820 and the secondary network 2840 may include a number of switching elements and/or other elements (e.g., capacitors, etc.). The primary network 2820 may be driven by a DC source 2810. Embodiments of the secondary network 2840 include a number of load control modules 2845 each configured to control output parameters (e.g., voltage, current, etc.) for a respective load 2850.

For example, the primary network 2820 may switch the DC source 2810 for use as a driving signal for the primary side of the converter module 2830. The secondary side of the converter module 2830 may then be shared by the various load control modules 2845 of the secondary network 2840. Each of the load control modules 2845 may further switch the secondary-side signal from the primary network 2820 for application to its respective load 2850. A number of embodiments of circuits for implementing this type of functionality are described below.

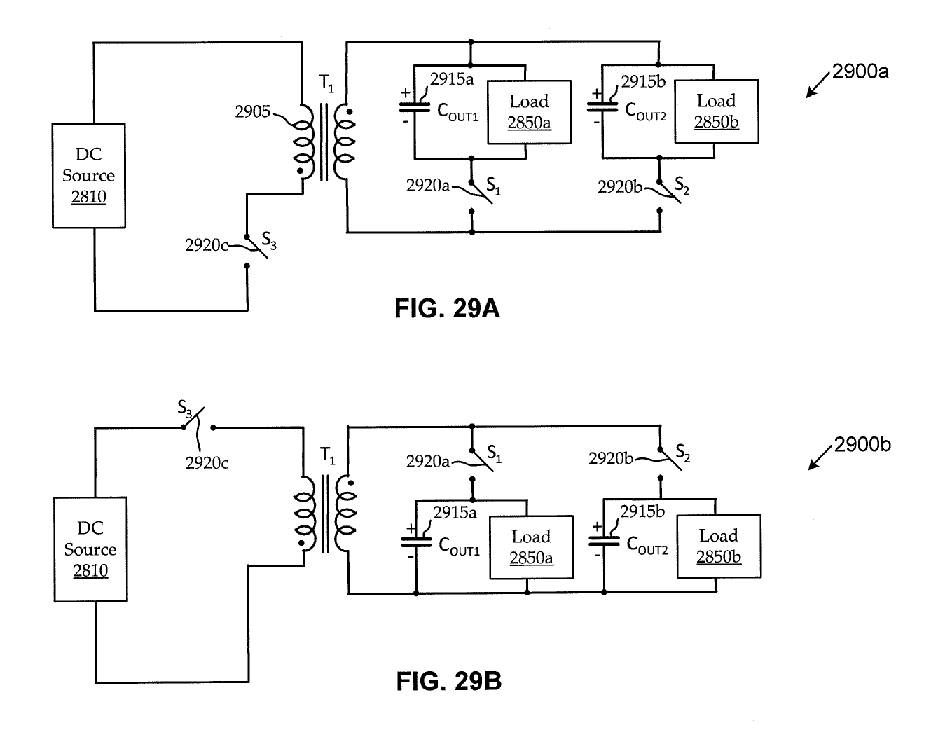

FIG. 29A illustrates an embodiment in which a flyback converter has two independently regulated outputs that share a common secondary winding. We will assume that the first output is the lower voltage. In a first operating state, switch 2920c is ON and current and energy build up in the coupled inductor 2905. When switch 2920c turns OFF, switch 2920a turns ON. Switch 2920a stays ON for a time determined by a control circuit that regulates the first output. While switch 2920a is ON, energy transfers from the coupled inductor 2905 to the first output capacitor 2915a and the first load 2850a. When switch 2920a turns OFF, switch 2920b turns ON and energy transfers from the coupled inductor 2905 to the second output capacitor 2915b and the second load 2850b. Switch 2920b turns OFF when the energy transferred to the second output is equal to the energy needed by the second load 2850b in a switching cycle. When switch 2920b turns OFF, switch 2920c turns ON and the cycle begins again. During a switching cycle, the amount of energy added to the coupled inductor 2905 during the first operating state equals the amount of energy delivered by the coupled inductor 2905 to the two loads 2850a and 2850b during the second operating state. The timing of the switches can be adjusted to maintain precise regulation of both outputs simultaneously.

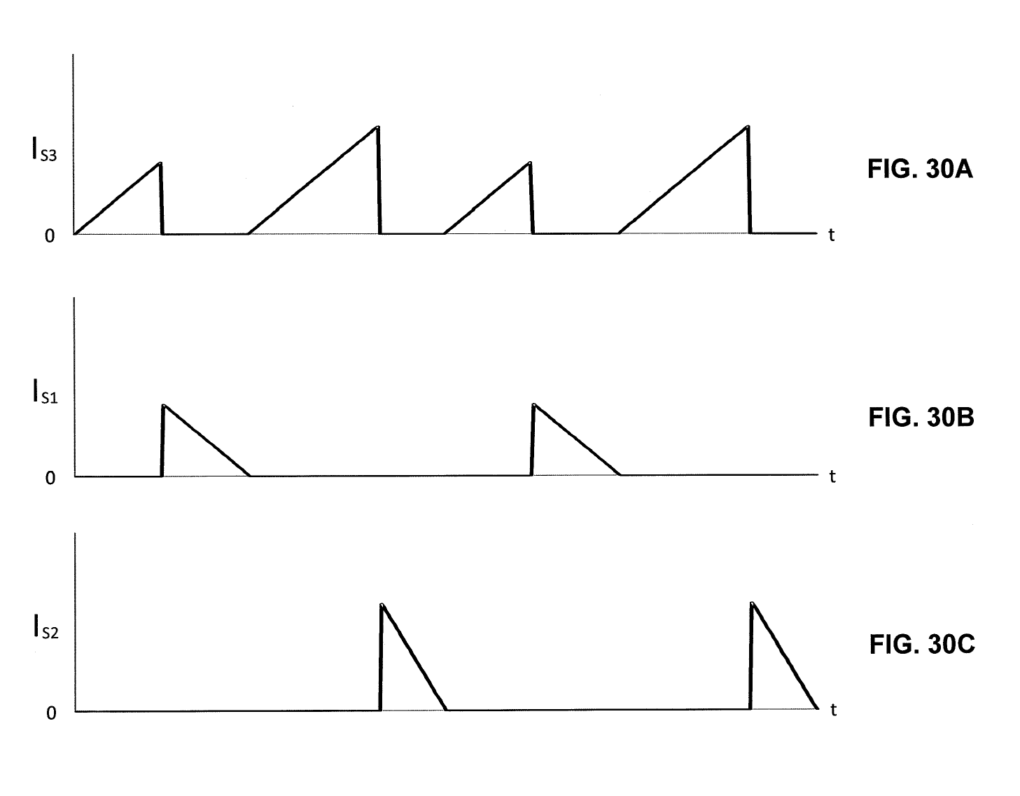

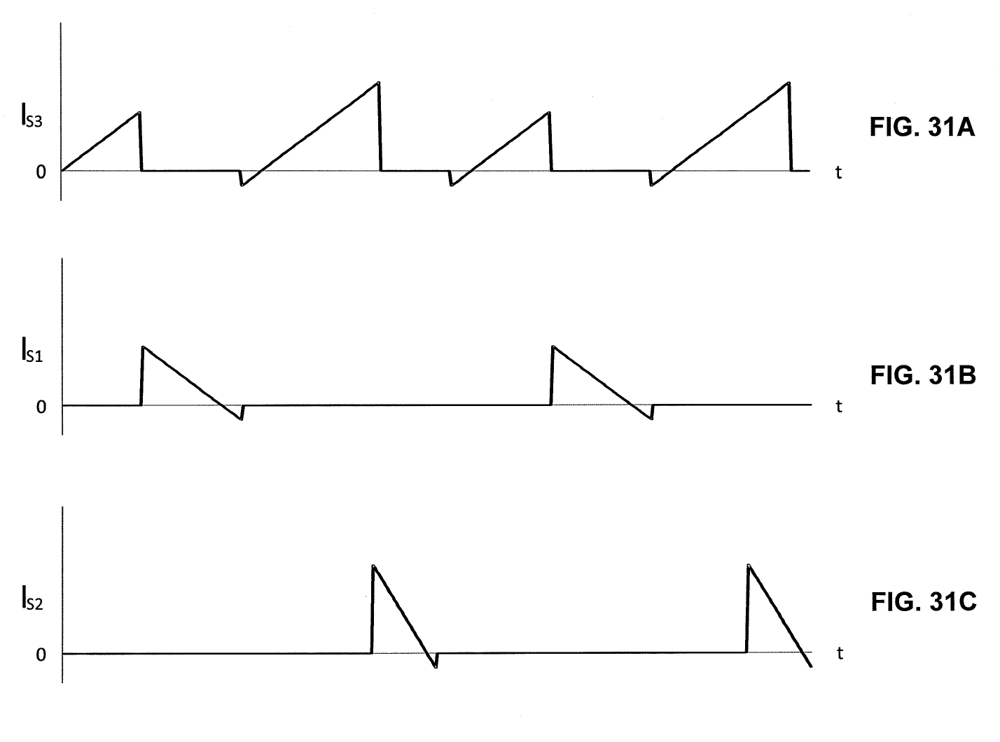

The FIG. 29B embodiment is identical to the FIG. 29A embodiment, except that the relative positions of switches and outputs are reversed in the secondary circuit networks of the two embodiments and the relative position of switch and winding is reversed in the primary circuit network. Current waveforms illustrating the operation of the FIG. 29A and FIG. 29B embodiments are provided in FIG. 30 and FIG. 31 for the operation described above.

FIGS. 30A-C illustrate a mode of operation in which the flyback transformer has a small inductance and operates in discontinuous conduction mode. In this mode the converter powers the first load in one cycle and it powers the second load in the next cycle. The converter alternates between the two outputs on alternate switching cycles, and the frequency can vary and there is no dead time between switching cycles. The FIG. 30 operating mode is the critical conduction mode or boundary mode, since the converter operates on the boundary between discontinuous conduction mode and continuous conduction mode.

A control mode similar to boundary mode is illustrated in FIGS. 31A-C waveforms. The difference between the FIG. 31 waveforms and the FIG. 30 waveforms lies in the reversal of current illustrated in the FIG. 31 waveforms. The current reversal creates a condition in which energy is available to drive a zero voltage switching transition (ZVS) for the main switch. The FIG. 31 operating mode is called ZVS boundary mode control.

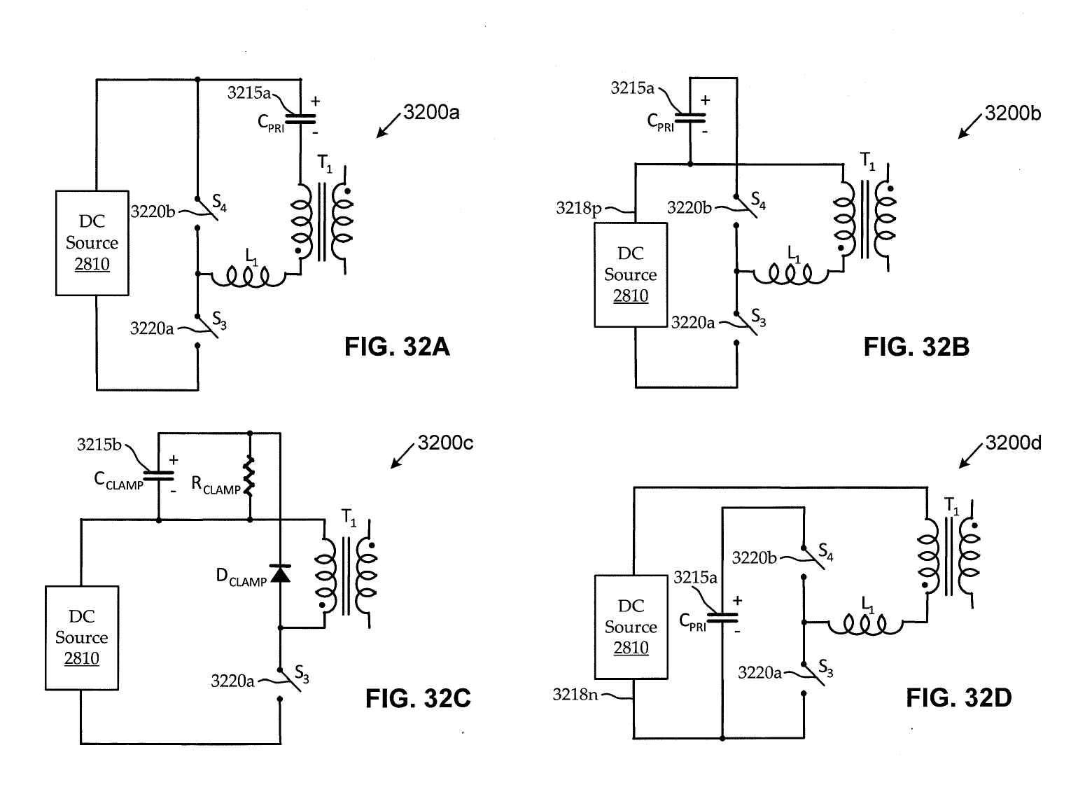

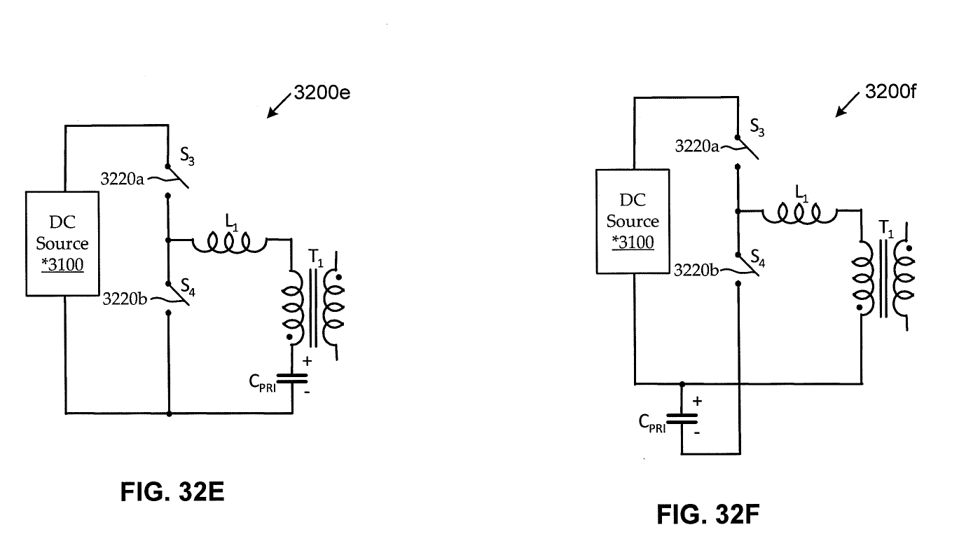

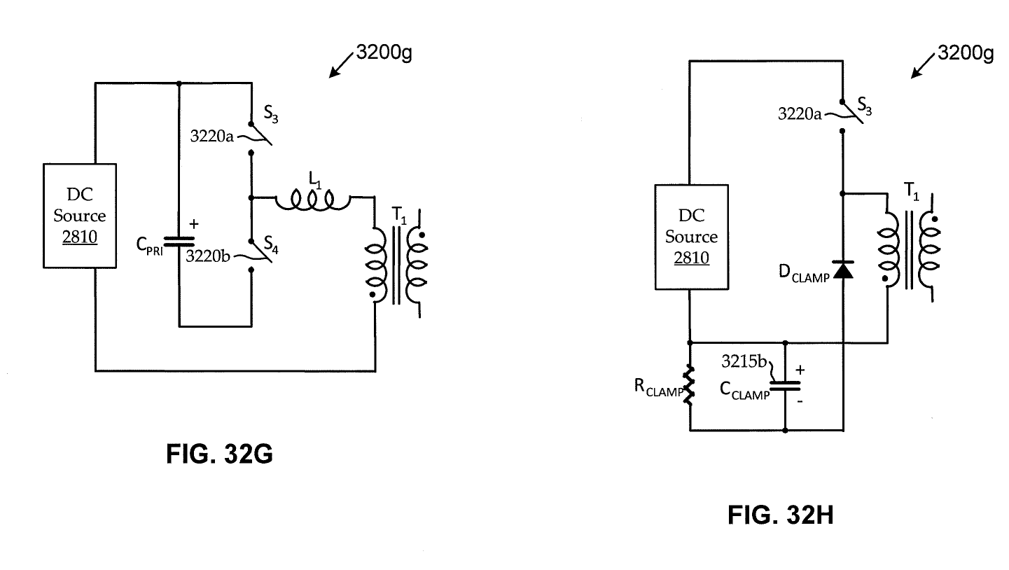

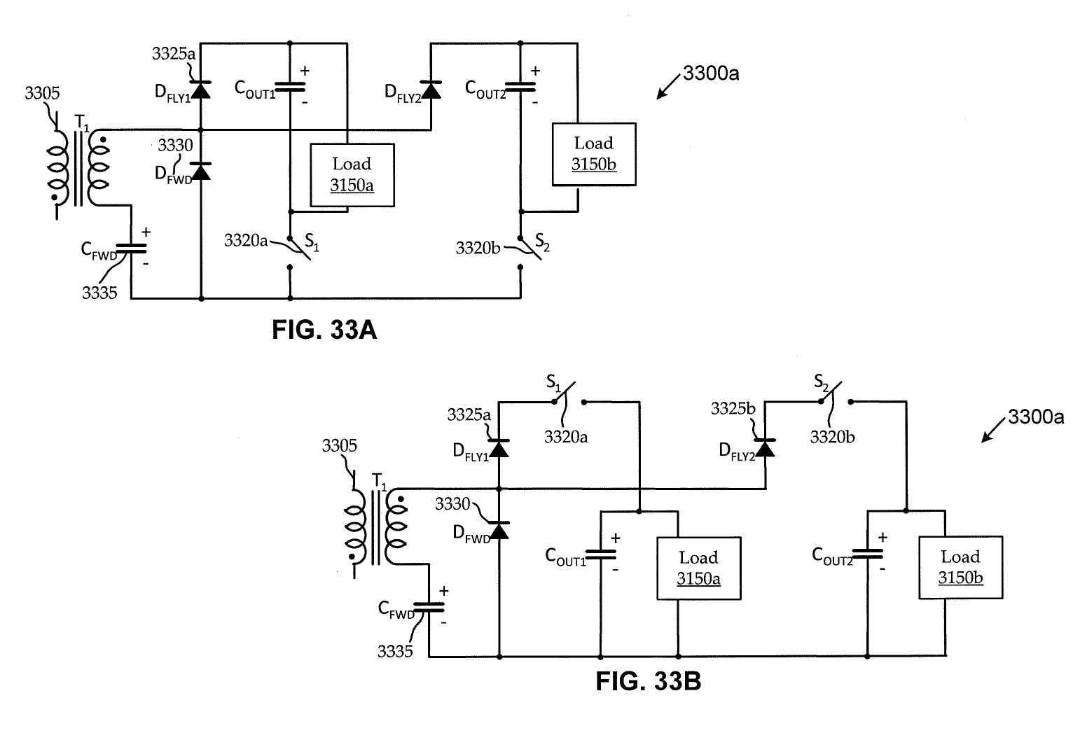

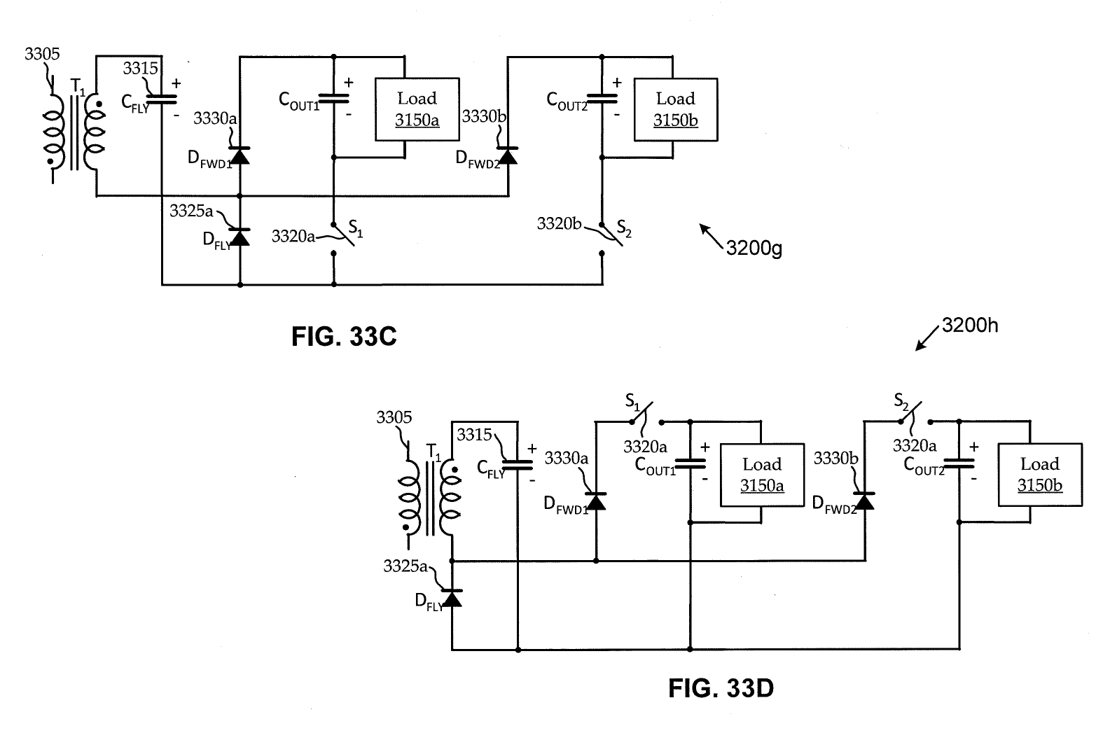

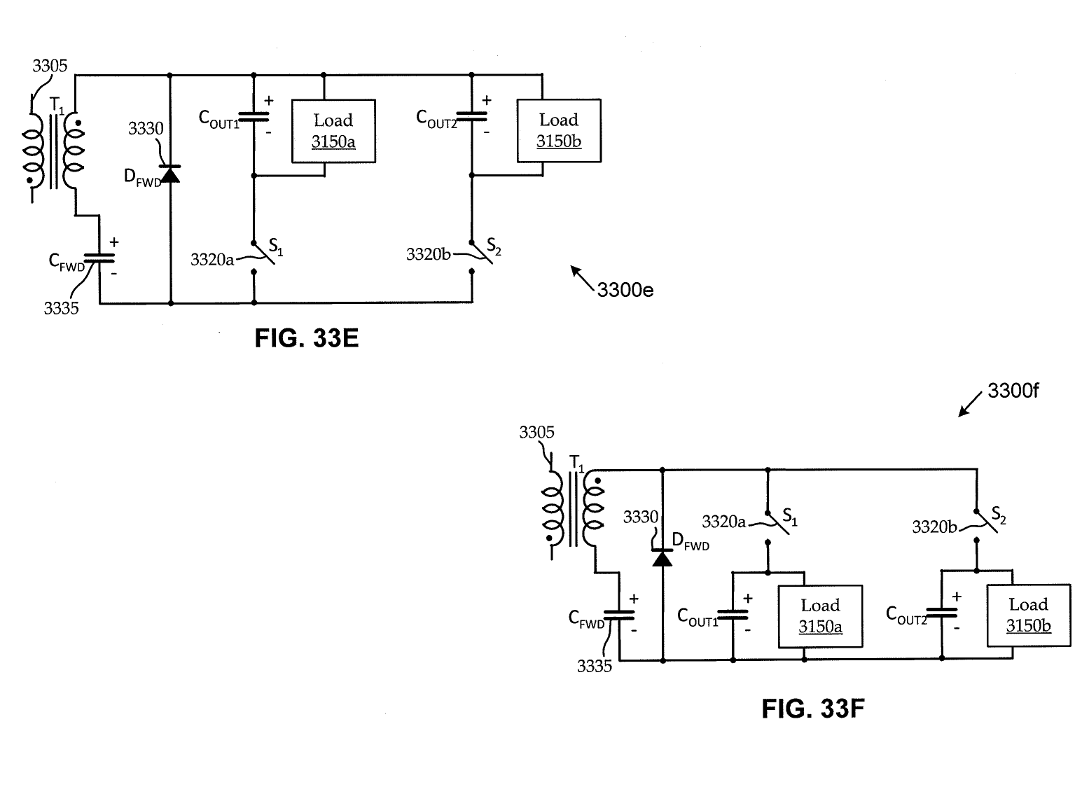

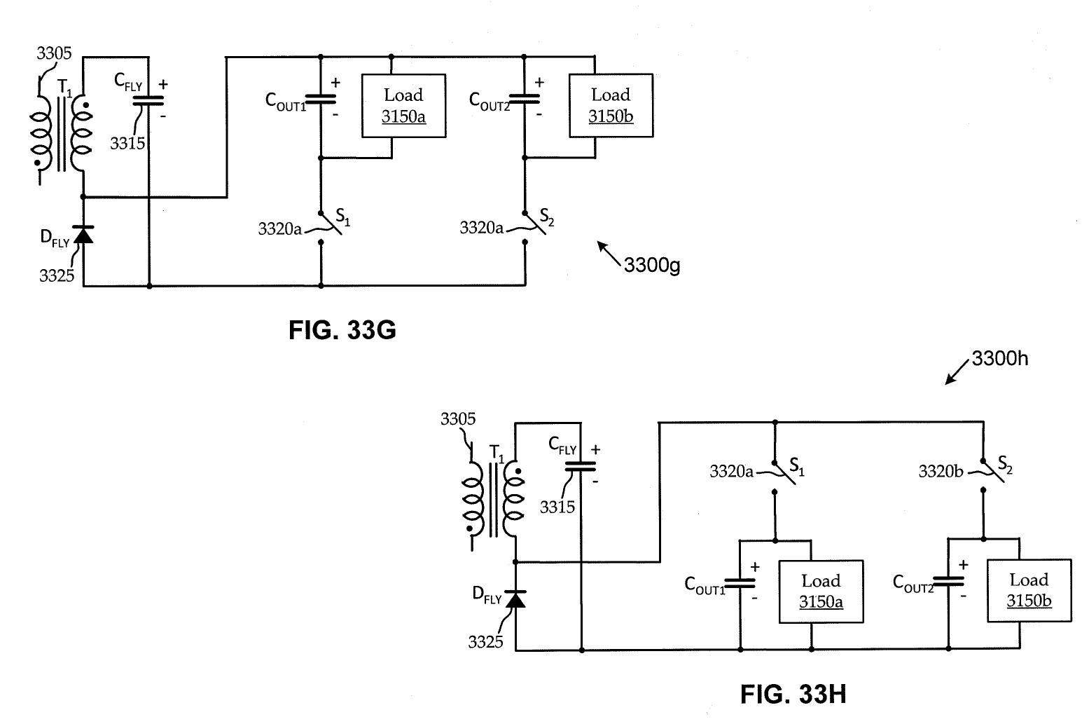

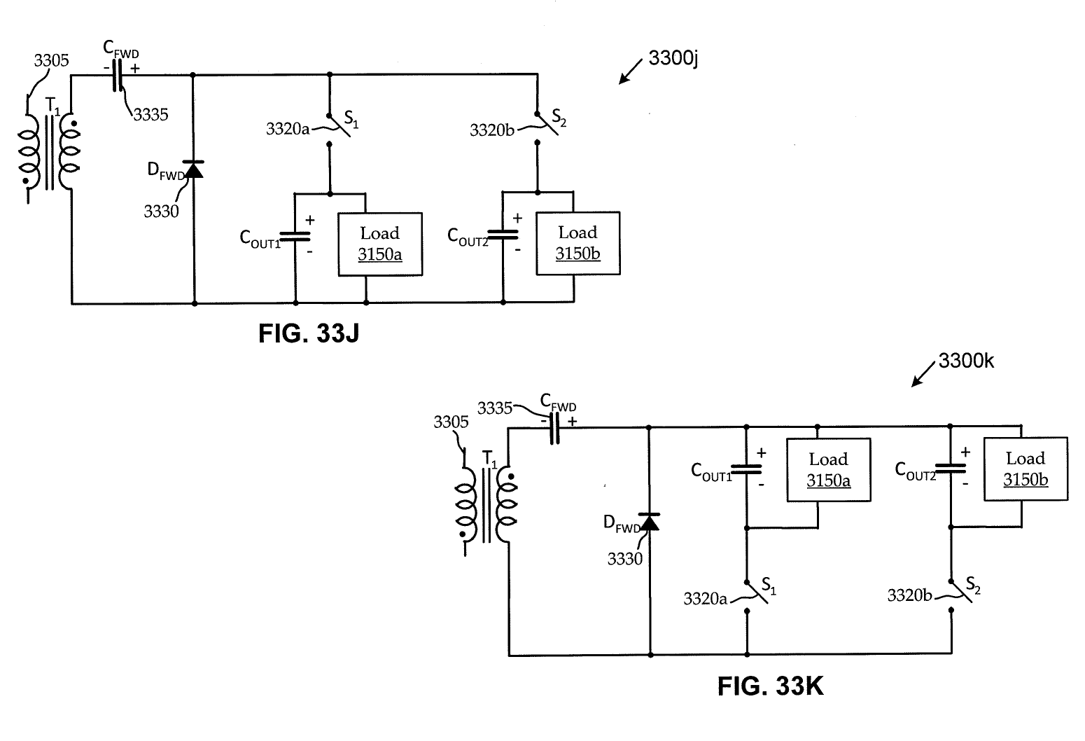

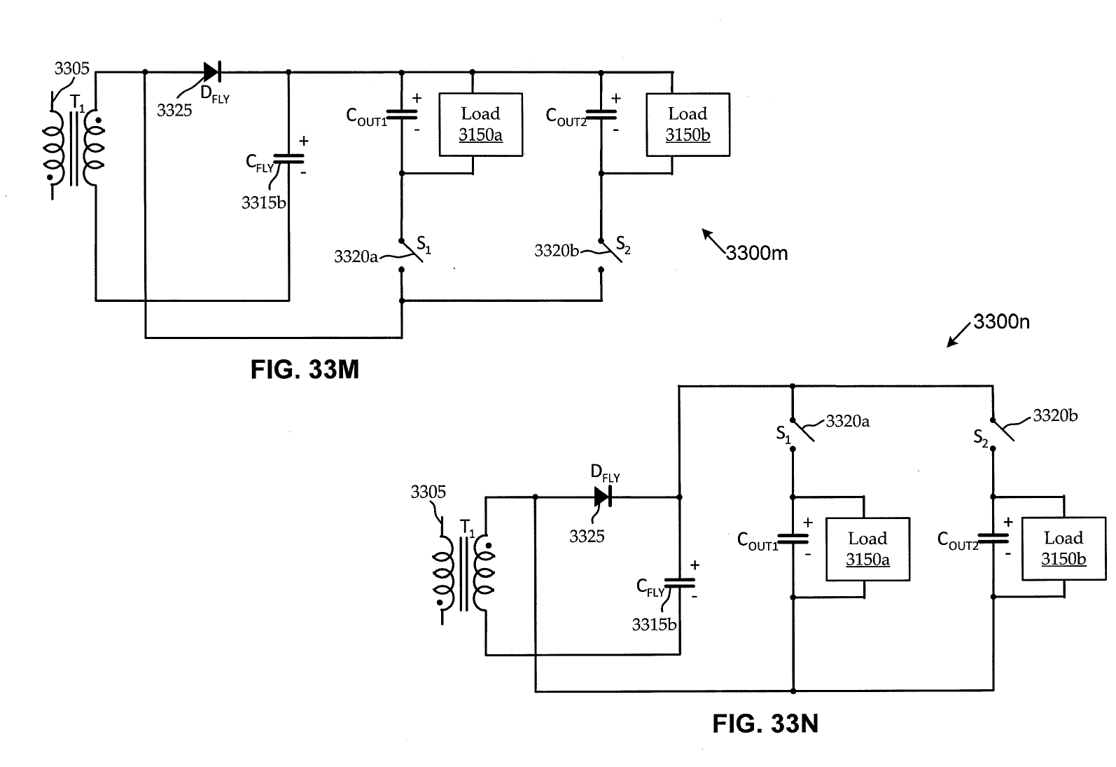

The embodiments of FIG. 29A and FIG. 29B are simple flyback embodiments, but there are many variations of the flyback converter and other related coupled inductor converters to which the structures and techniques revealed in this application apply. FIGS. 32A-F illustrate variations in the primary circuit networks that can be made to the embodiments of FIG. 29A and FIG. 29B that represent additional embodiments. Alternative secondary circuit networks are also possible and represent alternative additional embodiments. FIGS. 29A-B and FIGS. 33A-N all illustrate alternative secondary circuit networks that can be combined with the primary circuit networks of FIGS. 29A-B, FIGS. 32B-D, and FIGS. 32F-H to create embodiments, all of which share certain features. The FIG. 32A and FIG. 32E primary circuit networks do not yield circuits having output parameters that can be regulated when combined with some of the secondary circuit networks listed above, but the FIG. 32A and FIG. 32E primary circuit networks may be combined with the secondary circuit networks of figures FIG. 29A and FIG. 29B to yield embodiments with independently regulated outputs.

FIG. 32A illustrates a primary circuit network for a coupled inductor buck converter 3200a having a low side main primary switch 3220a. The FIG. 32E primary circuit network 3200e also applies to the coupled inductor buck converter, but uses a high side main primary switch 3220a. FIG. 32B and FIG. 32D illustrate primary circuit networks 3200b, 3200d for a coupled inductor boost converter or a flyback converter with an active clamp network for eliminating ringing during the OFF time of the main primary switch and with a low side main primary switch 3220a. In the FIG. 32B embodiment, the primary capacitor 3215a connects to the positive input terminal 3218p, and in the FIG. 32D embodiment the primary capacitor 3215a connects to the negative input terminal 3218n.

FIG. 32F and FIG. 32G illustrate primary circuit network embodiments similar to those of FIG. 32B and FIG. 32D but with the relative positions of switches and windings reversed. FIG. 32C and FIG. 32H add passive dissipative leakage inductance clamps 3215b to the FIG. 29A and FIG. 29B primary circuit network embodiments.

Some embodiments of operations of the primary circuit networks illustrated in FIGS. 32A-B and FIGS. 32D-G combined with the secondary networks illustrated in FIGS. 29A-B and FIGS. 33A-N for single output converters and multi-output converters having a single output per secondary winding are described in detail in U.S. Pat. No. 5,402,329, titled “Zero Voltage Switching Pulse Width Modulated Power Converters,” filed Dec. 9, 1992; U.S. Pat. No. 6,452,814, titled “Zero Voltage Switching Cells For Power Converters,” filed Sep. 19, 2001; and U.S. Pat. No. 7,551,459, titled “Zero Voltage Switching Coupled Inductor Boost Power Converters,” filed Jan. 25, 2007; all of which are hereby incorporated by reference. Embodiments contribute novel structure and operation for achieving multiple outputs from a single secondary winding. The structure and techniques unique to achieving multiple independently regulated outputs are addressed by embodiments described herein.

The FIG. 32A and FIG. 32E primary circuit networks are applicable to coupled inductor buck converters and can be combined with the secondary circuit networks of figures FIGS. 29A-B. The primary circuit networks of FIGS. 29A-B can be combined with any of the secondary circuit networks of FIGS. 29A-B and FIGS. 33A-N to form useful flyback and coupled inductor boost combinations in addition to the combinations described in the paragraphs above. Each of the useful combinations shall be considered additional embodiments.

Any of the primary circuit networks described above, except the FIG. 32A and FIG. 32E primary circuit networks, can be combined with the FIGS. 29A-B secondary circuit networks to form flyback converters. Any of the primary circuit networks described above, except the FIG. 32A and FIG. 32E primary circuit networks, can be combined with any of the secondary circuit networks, except the FIGS. 29A-B secondary circuit networks, to form coupled inductor boost converters. Coupled inductor boost converters have two secondary switches. One of the secondary switches, 3220a or 3220b, of the coupled inductor boost converter is only active when the main primary side switch 2920c is active during a first operating state. The other secondary switch, 3220a or 3220b, is only active when main primary side switch 2920c is OFF during the second operating state.

In order to achieve independently regulated outputs from a single secondary winding in a coupled inductor boost converter only one of secondary switches 3220a, 3220b must be duplicated to add another output. Either of the secondary side switches in the coupled inductor boost can be duplicated to form converters with multiple independently regulated outputs using a single secondary winding.

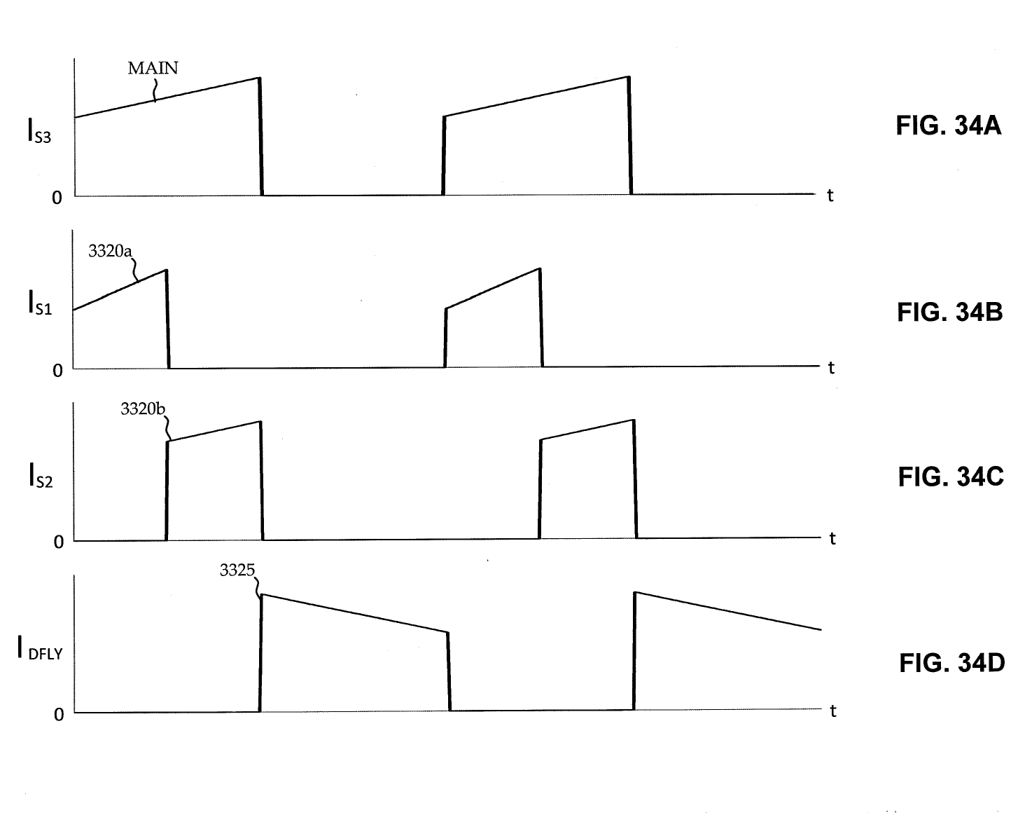

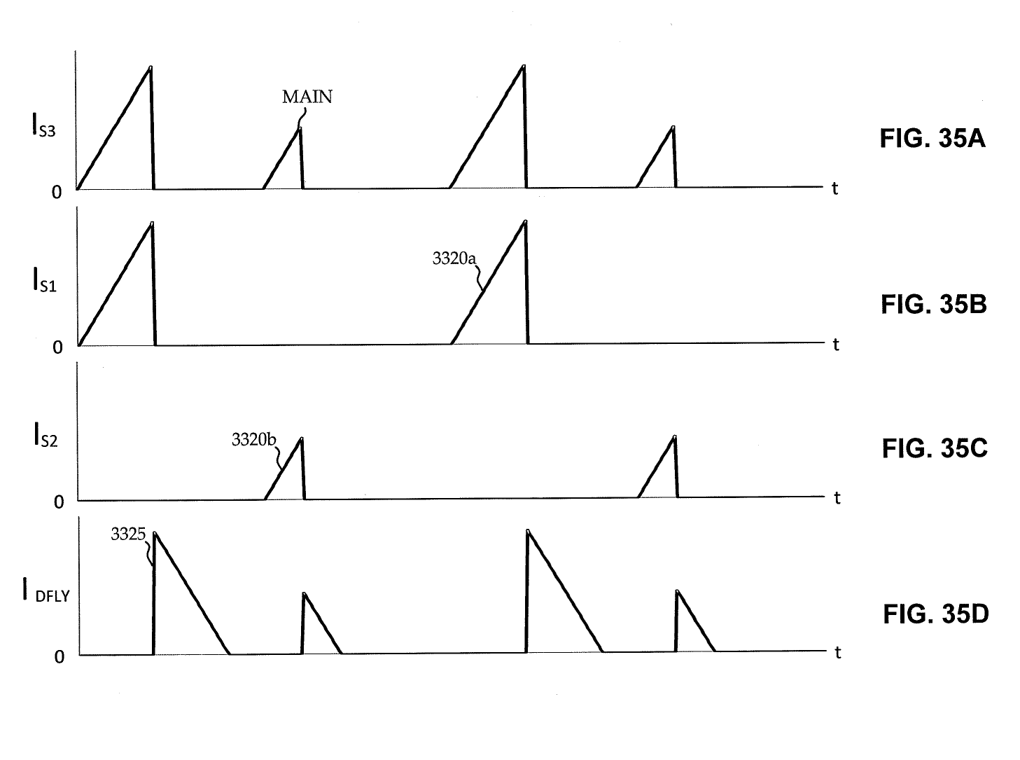

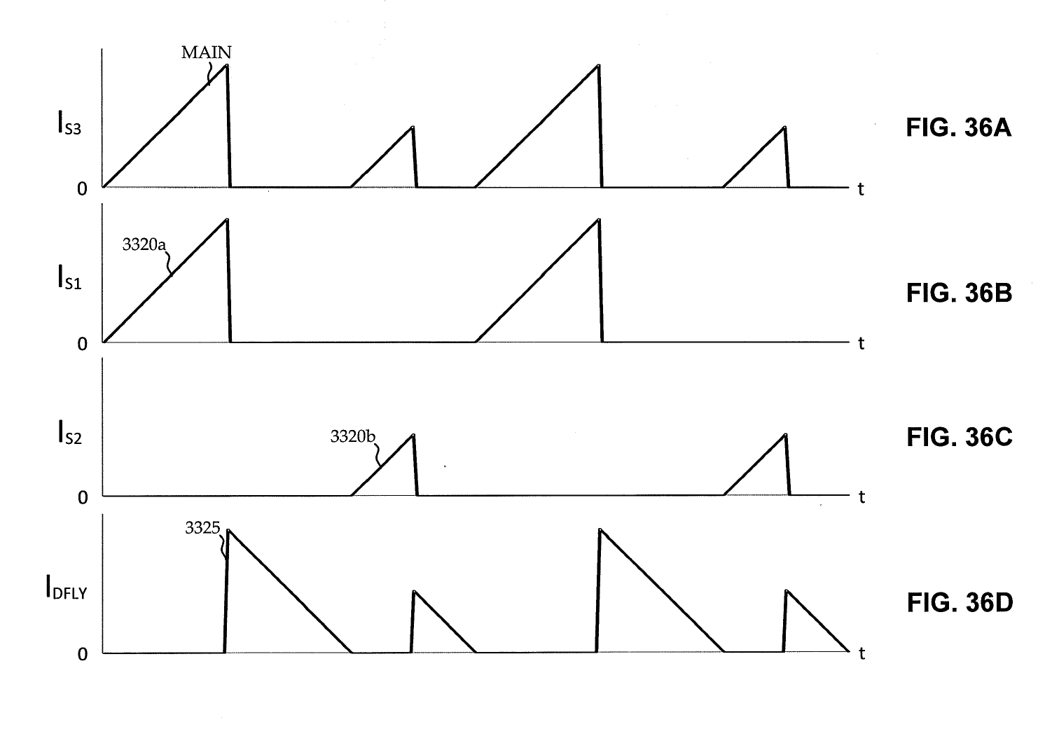

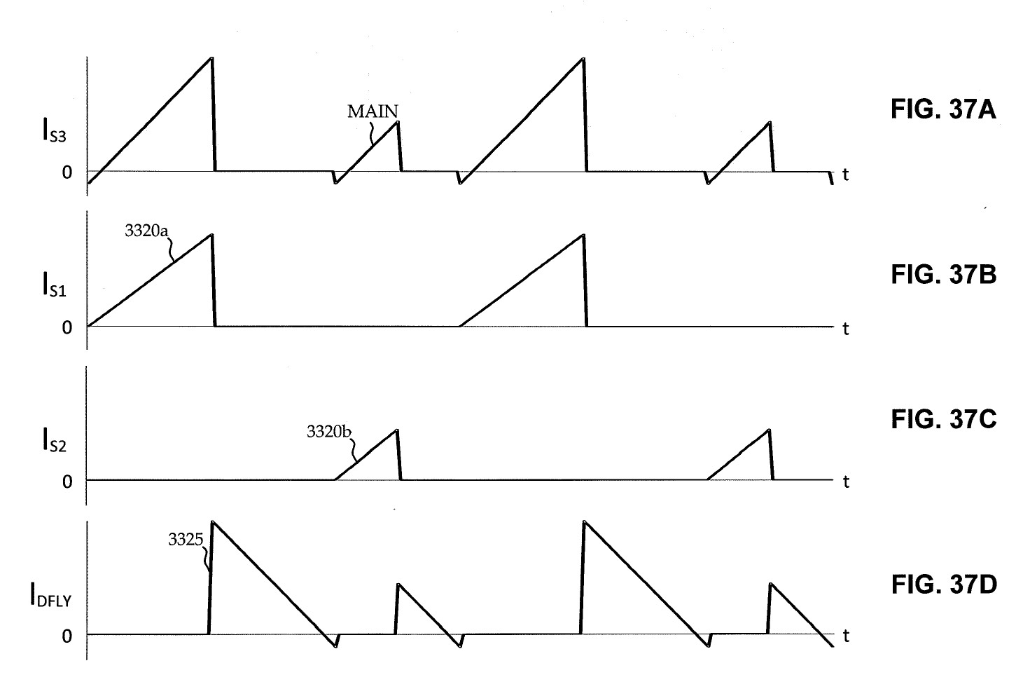

The secondary circuit networks illustrated in FIGS. 33A-N are all secondary circuit networks for coupled inductor boost converters. The secondary circuit networks that contain a flyback diode 3325a and a flyback capacitor 3315 have multiple secondary switches that operate sequentially during the same first operating state or operate alternately on alternate switching cycles during sequential first operating states. Current waveforms illustrating the various control schemes that may be used with secondary circuit networks containing flyback diode 3325a and flyback capacitor 3315 are illustrated in FIGS. 34A-D, FIGS. 35A-D, FIGS. 36A-D, and FIGS. 37A-D.

FIGS. 34A-D illustrate current waveforms for continuous conduction mode. FIGS. 35A-D illustrate current waveforms for discontinuous conduction mode. FIGS. 36A-D illustrate current waveforms for critical conduction mode. FIGS. 37A-D illustrate current waveforms for ZVS boundary mode. For ZVS boundary mode control, flyback diode 3325a must be a synchronous rectifier in order to accomplish the reverse conduction required. The secondary circuit networks that contain flyback diode 3325a and a flyback capacitor 3315 have multiple secondary switches that operate sequentially during the same second operating state or operate alternately on alternate switching cycles during sequential second operating states.

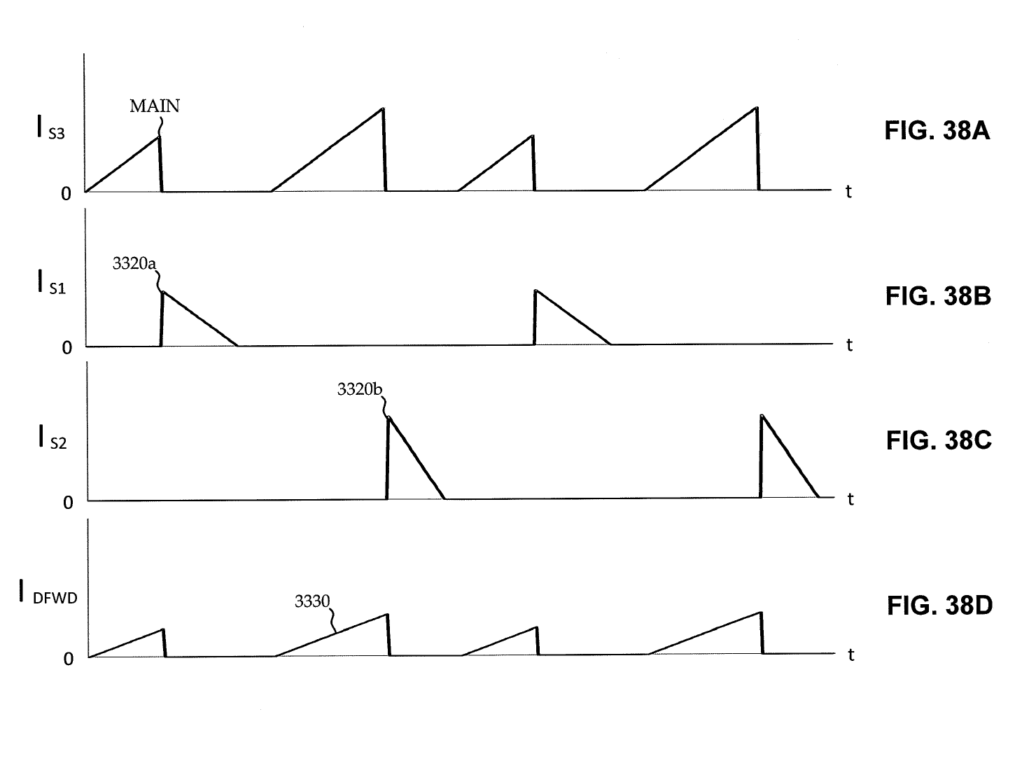

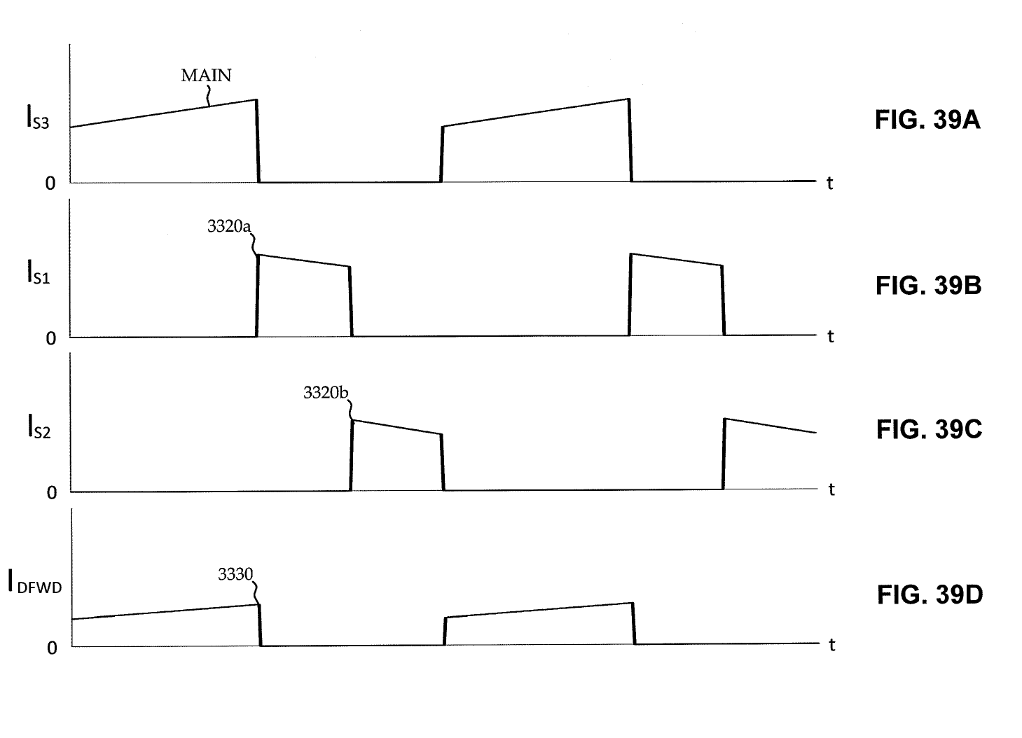

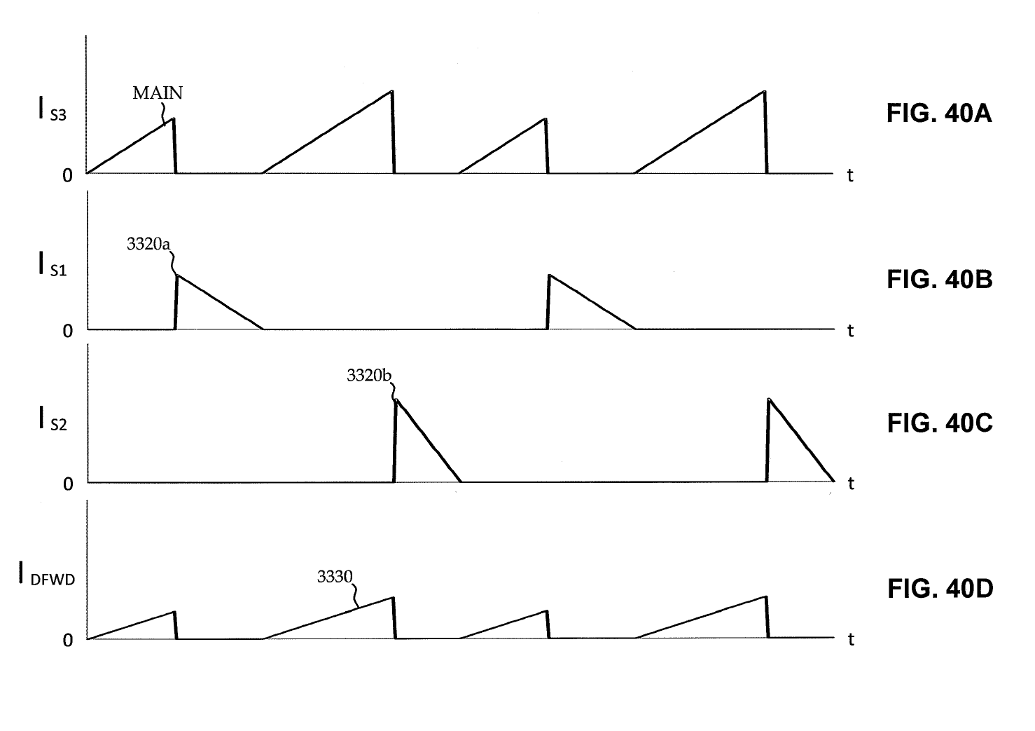

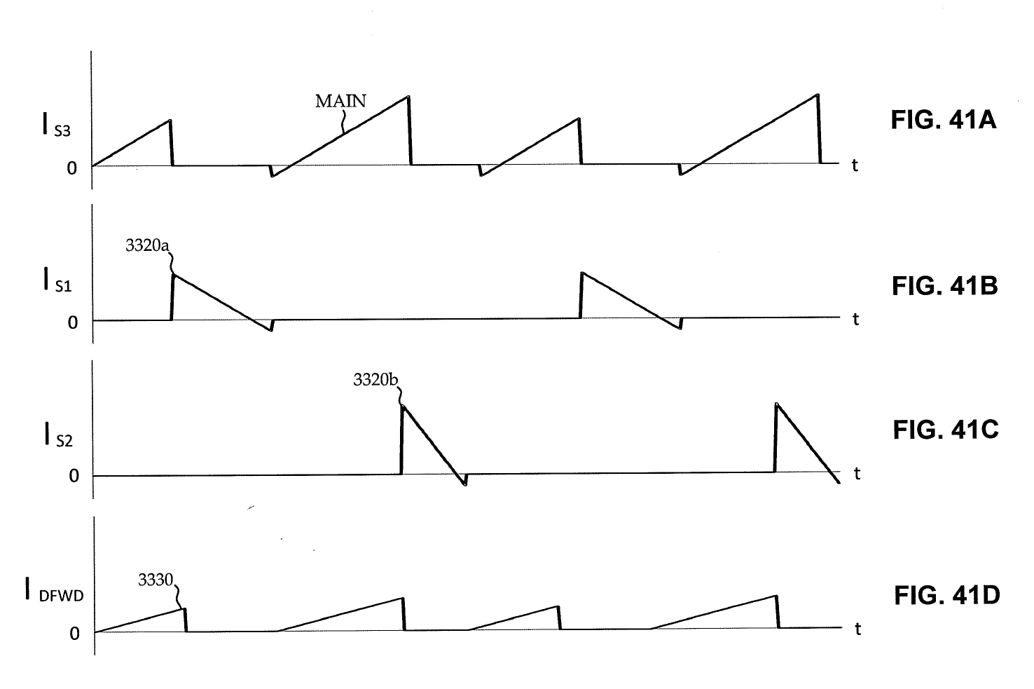

Current waveforms illustrating the various control schemes that may be used with secondary circuit networks containing the flyback diode 3325a and flyback capacitor 3315 are illustrated in FIGS. 38A-D, FIGS. 39A-D, FIGS. 40A-D, and FIGS. 41A-D. FIGS. 38A-D illustrate current waveforms for discontinuous conduction mode. FIGS. 39A-D illustrate current waveforms for continuous conduction mode. FIGS. 40A-D illustrate current waveforms for critical conduction mode.

FIGS. 41A-D illustrate current waveforms for ZVS boundary mode. For ZVS boundary mode control, switches 3320a and 3320b of the FIG. 33 embodiments must allow reverse current conduction. For the FIG. 33 embodiments that have a significant amount of inductance in series with the coupled inductor 3305, the series inductance alters current waveforms to an extent that depends on the amount of series inductance. Series inductance causes delays in current waveforms and causes the current waveforms to have ramps that rise and fall linearly in magnitude over time. The rates of rise and fall are inversely dependent on the magnitude of the series inductance. In some cases, the presence of series inductance provides the benefit of zero voltage switching, as described, for example, in some of the U.S. patents incorporated by reference above.

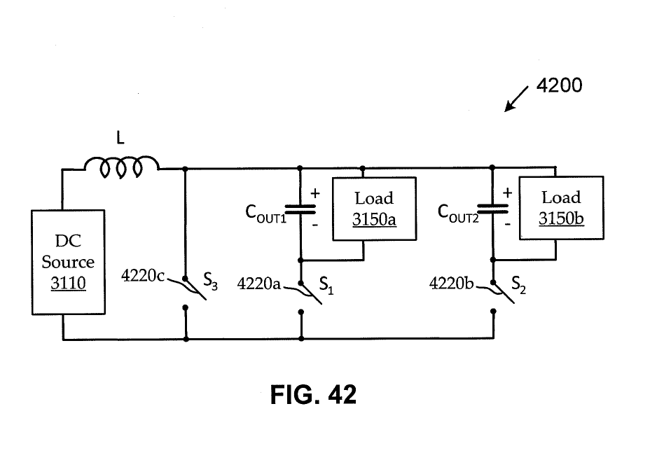

FIG. 42 illustrates a boost embodiment 4200 configured to produce at least one output voltage that is higher than the input voltage. However, some of the output voltages may be lower than the input voltage. A main boost switch 4220c is ON during a first operating state and switches 4220a and 4220b are operated sequentially during a second operating state. Alternate control methods that can also achieve independent regulation of first and second outputs 3150a and 3150b rely on switches 4220a and 4220b operating on alternate cycles, as illustrated in FIG. 30 and FIG. 31. Timing of switches 4220a, 4220b, and 4220c is set to achieve simultaneous regulation of both outputs.

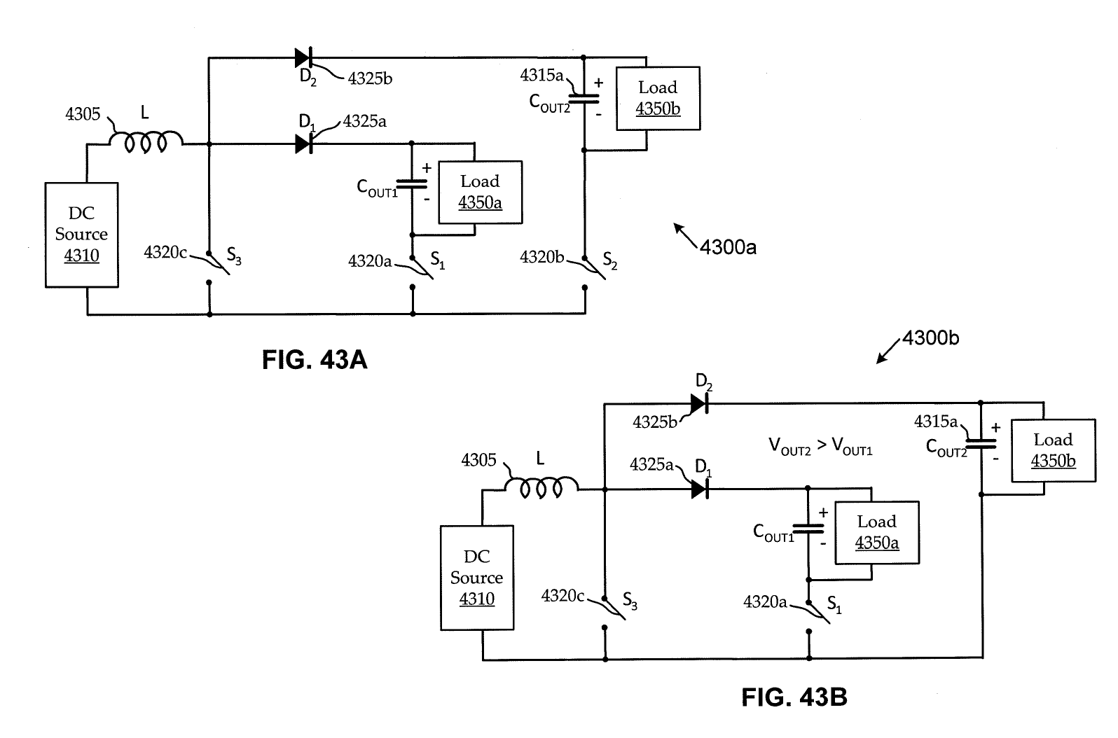

FIG. 43A illustrates a boost embodiment similar to the FIG. 42 embodiment in which the switches are divided into two parts, one part of which comprises diode rectifiers 4325a and 4325b, which prevent an output capacitor 4315a discharging current, and switches 4320a and 4320b having the ability to block output capacitor charging 4315a current. Switches 4320a and 4320b may have overlapping conduction. If a second load 4350b voltage is greater than a first load 4350a voltage, diode 4325b will not conduct if switches 4320a and 4320b are both on because diode 4325a is reverse biased. When switch 4320a turns OFF, the energy stored in an inductor 4305 will forward bias diodes 4325a and 4325b, which will conduct until switch 4320a turns OFF and switch 4320c turns ON. This suggests that switch 4320b is unnecessary, as illustrated in FIG. 43B, since diode 4325b turns OFF when switch 4320c turns ON.

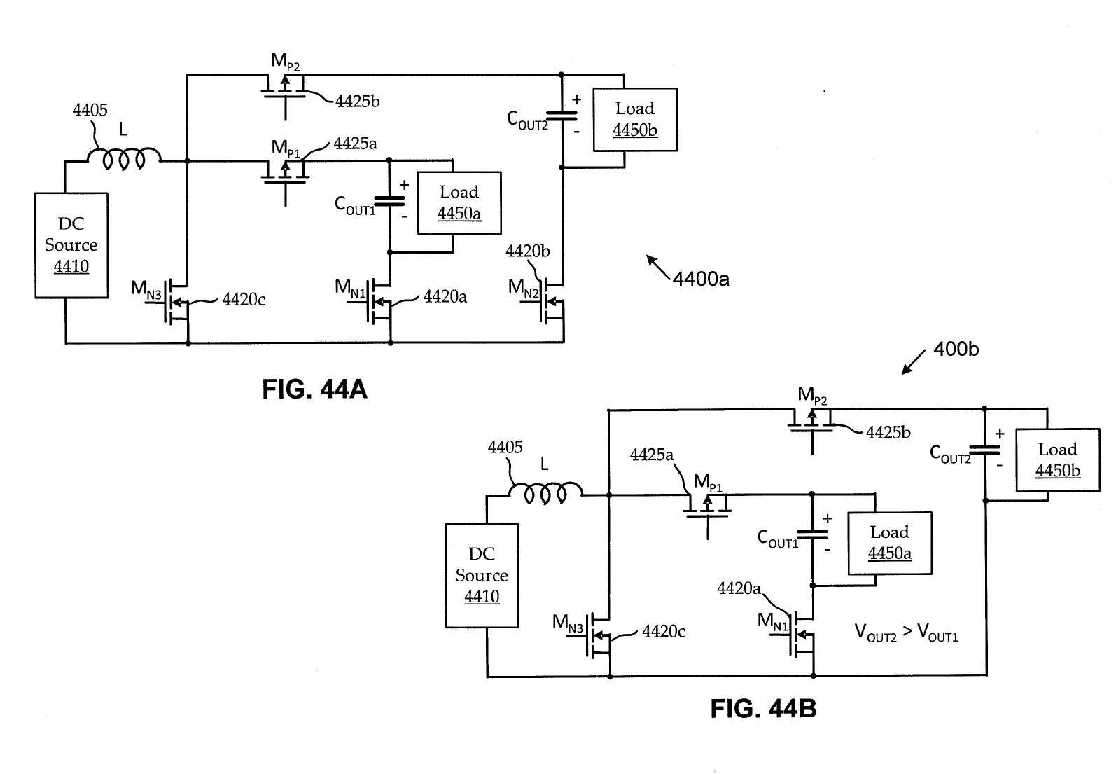

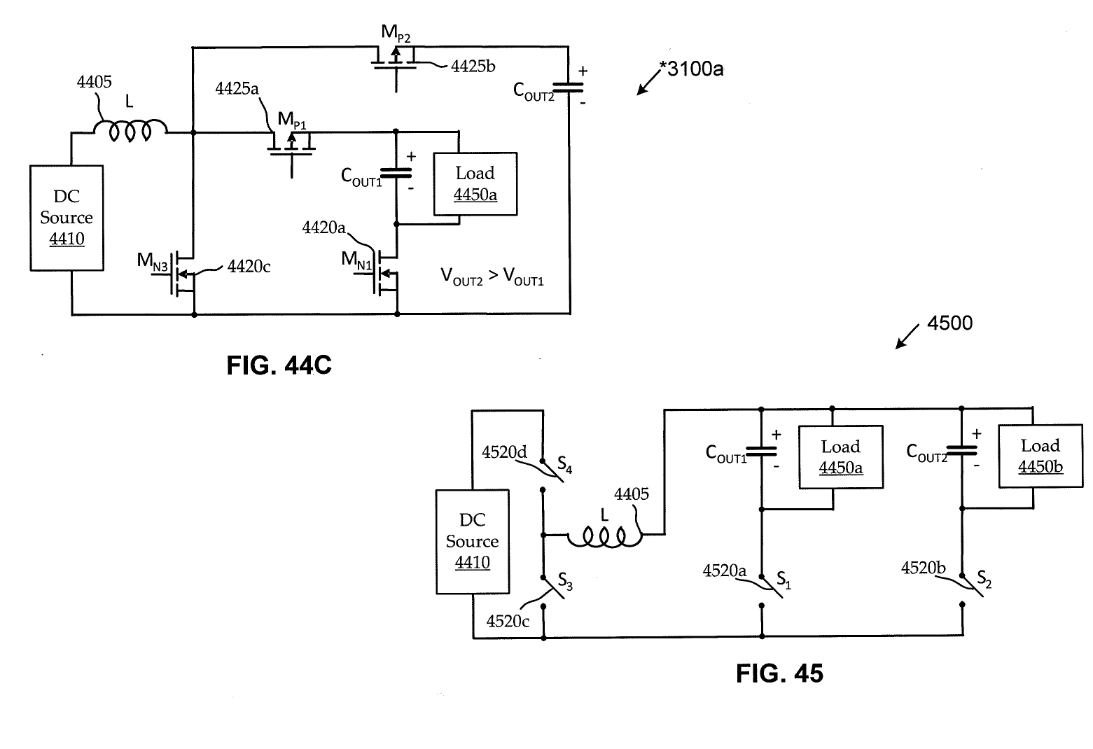

FIG. 44A is an embodiment identical to the FIG. 43A embodiment except that it uses synchronous rectifiers 4425a and 4425b instead of the diode rectifiers. FIG. 44B is an embodiment identical to the FIG. 44A embodiment except that a switch 4420b of FIG. 44A is deleted from the FIG. 44B embodiment. For applications in which a second load 4450b voltage is greater than a first load 4450a voltage, switch 4420b of FIG. 44A is unnecessary. The FIG. 44C embodiment is an embodiment similar to the FIG. 44B embodiment in which second output 4450b is unloaded and serves to reverse an inductor 4405 current so that magnetizing energy in inductor 4405 will be available to drive a ZVS turn ON transition for switch 4420c when switch 4425b is turned OFF. ZVS boundary mode control would be a suitable control scheme for the FIG. 44C embodiment.

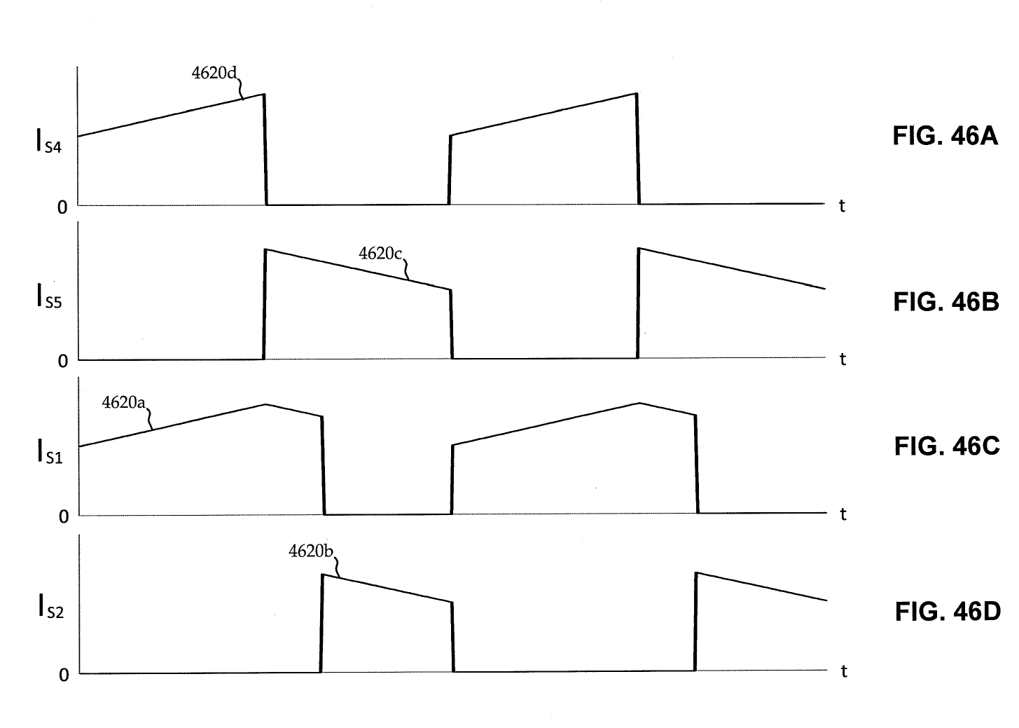

FIG. 45 is a buck converter embodiment. Since the buck inductor 4405 delivers current to the loads 4550a and 4550b during both the ON time and the OFF time of the main buck switch 4520d, the output switches 4520a and 4520b can be turned ON and OFF at any time and do not need to be synchronized to switches 4520c and 4520d in any way. Current waveforms that are synchronized to the turn ON of switch 4520d are illustrated in FIGS. 46A-D. In the FIG. 45 embodiment, one or the other of switches 4520a or 4520b should be ON at all times, except for very brief switch transition times, and the switches 4520a and 4520b should not overlap.

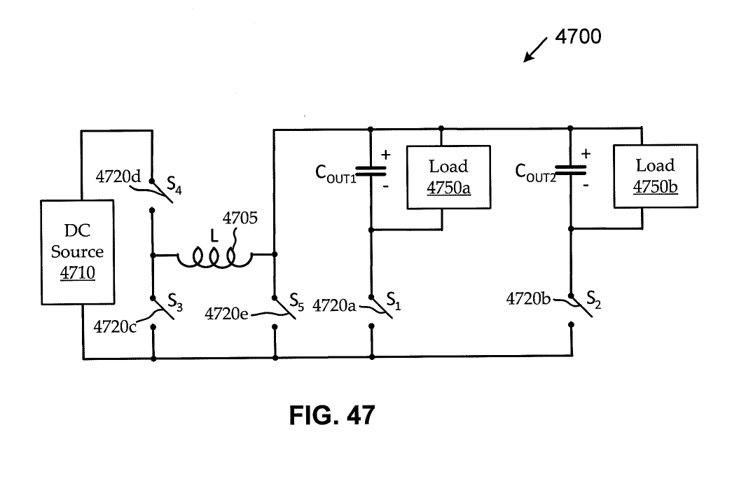

FIG. 47 is an embodiment that combines buck and boost embodiments using a single common choke 4705. This embodiment can operate as a step up, a step down converter, or both step up and step down converter. If switches 4720c and 4720d are operated in synchronization, this embodiment has a SEPIC transfer function and the output voltages can have any values greater than or less than the input voltage 4710. If this embodiment is operated with switch 4720d ON and switch 4720e OFF, switch 4720c can be modulated to produce two output voltages larger than input voltage 4710 or it can be operated to produce one voltage larger than input voltage 4710 and one voltage lower than input voltage 4710. The scheme that operates with switch 4720d ON and switch 4720e OFF is the most efficient operating scheme, but this scheme cannot produce two output voltages both lower than input voltage 4710. If this embodiment operates with switch 4720c OFF, the switch 4720d and switch 4720e switches modulate to produce two output voltages lower than input voltage 4710.

By modulating switches 4720c, 4720d, and 4720e, two output voltages, one less than input voltage 4710 and another greater than input voltage 4710 can be generated. If switches 4720c, 4720d, and 4720e are modulated but switches 4720c and 4720d are not synchronized, choke 4705 current can be made less and the converter can be made more efficient than the simpler modulation scheme in which switches 4720c and 4720d are synchronized.

A more efficient scheme has three operating states: a first operating state in which switch 4720d is ON and switches 4720c and 4720e are OFF; a second operating state in which switch 4720e is OFF and switches 4720c and 4720d are ON; and a third operating state in which switch 4720e is ON and switches 4720c and 4720d are OFF. Switches 4720a and 4720b may only be turned ON during the first and third operating states.

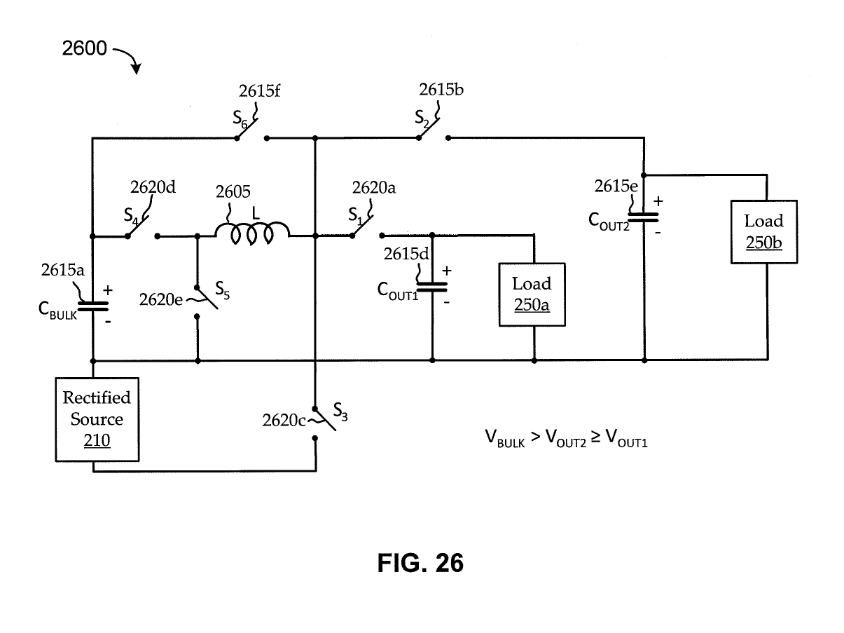

FIG. 26 illustrates another embodiment 2600 in some ways similar to the FIG. 47 embodiment. This embodiment offers both precise PFC and multiple independently regulated output voltages using only a single choke 2605 with a single winding. This embodiment requires six switches to achieve precise PFC and two independently regulated outputs.

In a first operating state, switches 2620c and 2620d are ON, current ramps up in inductor 2605, and the loads 250a and 250b are powered by their output capacitors 2615d and 2615e. In a second operating state, switches 2620a and 2620d are ON, current continues to ramp up in inductor 2605, but at a lower rate than the first operating state, first capacitor 2615d is replenished and first load 250a is powered by inductor 2605 current, and second output capacitor 2615e powers second load 250b. During the second operating state, switch 2620d may turn OFF and switch 2620e may turn ON. The switch 2620d ON to switch 2620d OFF and switch 2620e OFF to switch 2620e ON transition may occur during the second or third operating states or immediately following the third operating state. Switch 2620d and switch 2620e are operated substantially in anti-synchronization.

In a third operating state, switches 2620b and 2620d are ON, current continues to ramp up in inductor 2605, but at a lower rate than the first two operating states. Output capacitor 2615d powers the first load 250a, and output capacitor 2615e is replenished and the second load 250b is powered by inductor 2605 current. During a fourth operating state, switches 2620e and 2620f are ON, current ramps down in inductor 2605, which replenishes a bulk capacitor 2615a, and output capacitors 2615d, 2615e power the loads 250a, 250b.

In a fifth operating state, current in inductor 2605 has ramped down to zero, reversed direction, and is now ramping up in the negative direction and the output capacitors 2615d, 2615e power the loads 250a, 250b. In a sixth operating state, switches 2620c and 2620d are ON, current continues to flow in the negative direction in L but the inductor current is becoming more positive ramping towards zero current and the output capacitors power the loads. At the end of the fifth operating state, magnetizing energy in inductor 2605 is available to drive ZVS turn ON transitions for switches 2620c and 2620d.

In this embodiment all of the switching transitions can be ZVS transitions if the second output voltage is equal to or greater than the first output voltage and bulk energy storage capacitor 2615a voltage is equal to or greater than the output voltages. A conventional PFC timing circuit can be used to control switch 2615c to achieve a high power factor with a slow outer voltage loop that loosely regulates bulk energy storage capacitor 2615a voltage. The timing of switches 2620a and 2620b is independently controlled to achieve precise load regulation for loads 250a and 250b. The timing of switches 2620d and 2620e is independently controlled to regulate bulk energy storage capacitor 2615a voltage.

At line voltages near the peak of the AC line, net energy transfers into bulk energy storage capacitor 2615a. At line voltages near the AC crossover, bulk energy storage capacitor 2615a provides most of the energy to power both loads 250a and 250b and relatively little energy is drawn from the line, so net energy transfers out of bulk energy storage capacitor 2615a. Switches 2620a and 2620b must have bi-directional voltage blocking capability. Bi-directional voltage blocking switches can be made in standard silicon integrated circuit processes or these can be made by combining two series connected discrete transistors such as power MOSFETs or IGBTs. Switches 2620c, 2620d, 2620e, and 2620f need only block voltage in one direction.

It will now be appreciated that, by adding switches to single magnetic element converters and suitable control techniques, new converters having multiple independently controlled parameters can be formed. Single magnetic element converters with precise PFC and multiple precisely regulated outputs can be formed by adding switches and appropriate switch control elements to known converters. According to certain embodiments, a novel converter having a single element with a single winding that achieves high power factor, multiple independently regulated outputs and zero voltage switching is provided.

Circuits with higher orders of diode capacitance multipliers can be formed with higher output voltages by adding diodes and capacitors (e.g., to the converter 1800 of FIG. 18). Further embodiments may be achieved by using similar circuit topologies, but with multiple interleaved parallel circuits that share common capacitors, with polarity of the input or output reversed from that illustrated, having coupled magnetic circuit elements with more than two windings and circuits with more than one output, etc. Even further, while many embodiments are illustrated with simple switches, other embodiments may include N-channel MOSFETs, P-channel MOSFETs, IGBTs, JFETs, bipolar transistors, junction rectifiers, schottky rectifiers, etc. Other embodiments may also include additional circuit components, such as snubbers, both active and passive, and clamps for achieving improved electromagnetic compatibility. Still other embodiments may include current sense resistors and/or current transformers for sensing switch currents placed in series with one or more switches, for example, as these current sensing circuit elements may constitute a direct wire path to or from the switch (e.g., they may not significantly alter the operating currents or voltages of the circuit).

It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

It should also be appreciated that the systems, methods, and software may individually or collectively be components of a larger system, wherein other procedures may take precedence over or otherwise modify their application. Also, a number of steps may be required before, after, or concurrently with the following embodiments.

Specific details are given in the description to provide a thorough understanding of the embodiments. However, it will be understood by one of ordinary skill in the art that the embodiments may be practiced without these specific details. For example, well-known circuits, processes, algorithms, structures, waveforms, and techniques have been shown without unnecessary detail in order to avoid obscuring the embodiments.

Further, it may be assumed at various points throughout the description that all components are ideal (e.g., they create no delays and are lossless) to simplify the description of the key ideas of the invention. Those of skill in the art will appreciate that non-idealities may be handled through known engineering and design skills. It will be further understood by those of skill in the art that the embodiments may be practiced with substantial equivalents or other configurations. For example, circuits described with reference to N-channel transistors may also be implemented with P-channel devices, or certain elements shown as resistors may be implemented by another device that provides similar functionality (e.g., an MOS device operating in its linear region), using modifications that are well known to those of skill in the art.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Accordingly, the above description should not be taken as limiting the scope of the invention, as described in the following claims:

What is claimed is:

1. A power converter system, comprising:
a single-stage converter module configured to transform an input power signal into an output power signal for delivery to a load;
a power factor control subsystem, electrically coupled with the single-stage converter module and configured to substantially synchronize a current phase of the input power signal with a voltage phase of the input power signal; and
a load control subsystem, electrically coupled with the single-stage converter module and the load and configured to control an output parameter of the output power signal experienced by the load.

2. The power converter system of claim 1, wherein the power factor control subsystem comprises a switching network coupled with a switching control module configured to sequentially switch one or more switching elements of the switching network to substantially synchronize the current phase of the input power signal with the voltage phase of the input power signal.

3. The power converter system of claim 1, wherein the power factor control subsystem comprises one or more switching elements and one or more capacitive elements configured to draw substantially zero current from the input power signal when a voltage of the input power signal is substantially zero.

4. The power converter system of claim 3, wherein the switching elements are configured such that a net charge is transferred from the input signal into the capacitive elements when the voltage of the input signal is substantially near its peak.

5. The power converter system of claim 4, wherein the switching elements are configured such that the net charge is transferred from the capacitive elements to the load control subsystem through the single-stage power converter when the voltage of the input signal is substantially near zero.

6. The power converter system of claim 3, wherein the switching elements cycle between a first state and a second state, and an amount of energy drawn from the capacitive elements during the first state is substantially the same as the energy used by the load during both the first state and the second state.

7. The power converter system of claim 3, wherein at least two of the switching elements are configured to operate in a zero-voltage switching mode such that the at least two of the switching elements change from an OFF state to an ON state only when the voltage across the switch is substantially zero.

8. The power converter system of claim 3, further comprising a control subsystem configured to operate the switching elements such that the current phase of the input power signal is substantially synchronized with the voltage phase of the input power signal.

9. The power converter system of claim 1, wherein the load control subsystem comprises a switching network coupled with a switching control module configured to sequentially switch one or more switching elements of the switching network to control an output parameter of the output power signal experienced by the load.

10. The power converter system of claim 1, wherein the output parameter of the output power signal experienced by the load is the voltage or the current of the output power signal.

11. The power converter system of claim 1, wherein the output power signal comprises a plurality of power signals, wherein an output parameter of the output power signal experienced by each of the of the plurality of power signals is independently controlled by the load control subsystem.

12. The power converter system of claim 1, wherein the load control subsystem comprises one or more switching elements and one or more capacitive elements configured to control an output parameter of the output power signal experienced by the load.

13. The power converter system of claim 12, wherein:
the one or more switching elements are configured to operate in at least a first state and a second state;
the capacitive elements receive a net charge from the single-stage converter module during the first state; and
the capacitive elements supply net charge to the output power signal during the second state.

14. The power converter system of claim 13, wherein a transition between the first state and the second state is configured to control the output parameter of the output power signal experienced by the load.

15. A method for independently and concurrently controlling multiple parameters using a single magnetic element, the method comprising:
configuring a single magnetic element as a single-stage power converter configured to transform an input power signal into an output power signal for delivery to a load;
coupling a first switch network electrically with the single-stage power converter;
coupling a first switch controller with the first switch network, the first switch controller configured to control power factor of the input signal by sequentially switching at least a portion of the first switch network;
coupling a second switch network electrically with the single-stage power converter, the second switch network configured to switch the load output signal; and
coupling a second switch controller to the second switch network, the second switch controller configured to control a load output parameter by sequentially switching at least a portion of the second switch network.

16. A method for independently and concurrently controlling multiple parameters using a single magnetic element, the method comprising:
receiving an input power signal at a primary side of a single-stage power converter having a single magnetic element, the single-stage power converter electrically coupled with a power factor control module and a load control module;
transforming the input power signal at the primary side of the single-stage power converter to an output power signal at a secondary side of the single-stage power converter, for delivery to a load;
driving the power factor control module to substantially synchronize a current phase of the input power signal with a voltage phase of the input power signal; and
driving the load control module to control an output parameter of the output power signal experienced by the load, wherein driving the load control module is independent from and concurrent with driving the power factor control module.

17. The method of claim 16, wherein:
the power factor control module comprises a switching network coupled with a switching control module; and
driving the power factor control module comprises using the switching control module to sequentially switch one or more switching elements of the switching network to substantially synchronize the current phase of the input power signal with the voltage phase of the input power signal.

18. The method of claim 17, wherein the switching network of the power factor control module comprises the one or more switching elements and one or more capacitive elements and is configured to draw substantially zero current from the input power signal when a voltage of the input power signal is substantially zero.

19. The method of claim 18, wherein driving the power factor control module comprises:
switching the switching elements to transfer a net charge from the input signal into the capacitive elements when the voltage of the input signal is substantially near its peak; and
switching the switching elements to transfer the net charge from the capacitive elements to the load control module through the single-stage power converter when the voltage of the input signal is substantially near zero.

20. The method of claim 18, wherein driving the power factor control module comprises:
switching the switching elements to cycle between a first state and a second state, such that an amount of energy drawn from the capacitive elements during the first state is substantially the same as the energy used by the load during both the first state and the second state.

21. The method of claim 18, wherein driving the power factor control module comprises:
switching at least some of the switching elements in a zero-voltage switching mode such that the at least some of the switching elements change from an OFF state to an ON state only when the voltage across the switch is substantially zero.

22. The method of claim 16, wherein the output parameter of the output power signal experienced by the load is the voltage or the current of the output power signal.

23. The method of claim 16, wherein:
the output power signal comprises a plurality of power signals; and
driving the load control module to control the output parameter of the output power signal experienced by the load comprises driving the load control module to independently control an output parameter of each of the of the plurality of power signals.

24. The method of claim 16, wherein:
the load control module comprises one or more switching elements and one or more capacitive elements; and
driving the load control module comprises switching the one or more switching elements to control the output parameter of the output power signal experienced by the load.

25. The method of claim 24, wherein driving the load control module comprises:
switching the one or more switching elements to operate in at least a first state and a second state, such that the capacitive elements receive net charge from the single-stage power converter during the first state, and the capacitive elements supply net charge to the output signal during the second state; and
controlling a transition between the first state and the second state to control the output parameter of the output power signal experienced by the load.
